(19) United States
(12) Patent Application Publication
(10) Pub. No.: US 2026/0362247 A1
(43) Pub. Date: Nov. 12, 2026

(54) LIFE CYCLE MANAGEMENT SIGNALING FOR ARTIFICIAL INTELLIGENCE OR MACHINE LEARNING BASED MOBILITY

(71) Applicant: QUALCOMM Incorporated, San Diego, CA (US)

(72) Inventors: Rajeev KUMAR, San Diego, CA (US); Punyaslok PURKAYASTHA, San Diego, CA (US); Aziz GHOLMIEH, Del Mar, CA (US); Hamed PEZESHKI, San Diego, CA (US)

(21) Appl. No.: 19/664,485

(22) Filed: Apr. 30, 2026

Related U.S. Application Data
(60) Provisional application No. 63/802,482, filed on May 8, 2025.

(51) Int. Cl. H04W 36/00

(52) U.S. Cl. CPC H04W 36/0058; H04W 36/0072

(57) ABSTRACT

Various aspects of the present disclosure generally relate to wireless communication. In some aspects, a user equipment (UE) may receive, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The UE may transmit a measurement or prediction report including one or more measurements or predictions corresponding to the first set of one or more measurement targets or prediction targets in accordance with the configuration. The UE may receive a life cycle management message including an updated configuration that indicates a second set of one or more measurement targets or prediction targets. Numerous other aspects are described.

### CROSS-REFERENCE TO RELATED APPLICATION

This Patent Application claims priority to U.S. Provisional Patent Application No. 63/802,482, filed on May 8, 2025, entitled “LIFE CYCLE MANAGEMENT SIGNALING FOR ARTIFICIAL INTELLIGENCE OR MACHINE LEARNING BASED MOBILITY,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with life cycle management signaling for artificial intelligence or machine learning based mobility.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

The evolution of wireless communication technologies has ushered in advanced methodologies to enhance network performance and resource management. An aspect of this evolution is the integration of artificial intelligence and machine learning (AI/ML) techniques into network operations, specifically within radio access networks (RANs). AI/ML models are increasingly being employed in various applications such as beam management and mobility management in cellular networks. Beam management involves predicting and improving the paths through which radio signals are transmitted and received, ensuring efficient communication between a user equipment (UE) and network nodes. Mobility management focuses on maintaining seamless connectivity as UEs move through different network areas, necessitating predictions of handovers and network reconfigurations.

“UE mobility” refers to the ability of a UE to maintain continuous service as the UE moves geographically across different coverage areas within a cellular network. Mobility procedures may be triggered by various factors, including changes in signal strength, quality of service requirements, and network congestion. As a UE moves, it may transition from the coverage area of one cell to another, requiring a handover process to support uninterrupted service. The serving network node or cell is the current node providing service to the UE, managing a connection and data transmission. Neighbor network nodes or cells are adjacent nodes that may potentially take over service provision for the UE during a handover. Communications with neighbor and serving network nodes may be monitored for signal strength and quality to trigger a transition of service from the serving node to a neighbor node, helping the UE remain connected as it moves through the network.

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to receive, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The processing system may be configured to cause the UE to transmit, to the serving network node, a measurement or prediction report including one or more measurements or predictions corresponding to the first set of one or more measurement targets or prediction targets in accordance with the configuration. The processing system may be configured to cause the UE to receive, from the serving network node, a life cycle management message including an updated configuration that indicates a second set of one or more measurement targets or prediction targets associated with communications between the UE and at least one of the serving network node or the neighbor network node.

Some aspects described herein relate to a serving network node. The serving network node may include a processing system. The processing system may include one or more processors and one or more code-storing memories coupled with the one or more processors. The processing system may be configured to cause the serving network node to transmit, to a UE, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The processing system may be configured to cause the serving network node to receive, from the UE, a measurement or prediction report including one or more measurements or predictions corresponding to the first set of one or more measurement targets or prediction targets in accordance with the configuration. The processing system may be configured to cause the serving network node to transmit, to the UE, a life cycle management message including an updated configuration that indicates a second set of one or more measurement targets or prediction targets associated with communications between the UE and at least one of the serving network node or the neighbor network node.

Some aspects described herein relate to a first network node. The first network node may include a processing system. The processing system may include one or more processors and one or more code-storing memories coupled with the one or more processors. The processing system may be configured to cause the first network node to communicate, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node. The processing system may be configured to cause the first network node to transmit, to the second network node, an updated configuration that indicates a second set of one or more measurement targets or prediction targets associated with communications between the UE and at least one of the first network node or the second network node.

Some aspects described herein relate to a method of wireless communication performed by a UE. The method may include receiving, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The method may include transmitting, to the serving network node, a measurement or prediction report including one or more measurements or predictions corresponding to the first set of one or more measurement targets or prediction targets in accordance with the configuration. The method may include receiving, from the serving network node, a life cycle management message including an updated configuration that indicates a second set of one or more measurement targets or prediction targets associated with communications between the UE and at least one of the serving network node or the neighbor network node.

Some aspects described herein relate to a method of wireless communication performed by a serving network node. The method may include transmitting, to a UE, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The method may include receiving, from the UE, a measurement or prediction report including one or more measurements or predictions corresponding to the first set of one or more measurement targets or prediction targets in accordance with the configuration. The method may include transmitting, to the UE, a life cycle management message including an updated configuration that indicates a second set of one or more measurement targets or prediction targets associated with communications between the UE and at least one of the serving network node or the neighbor network node.

Some aspects described herein relate to a method of wireless communication performed by a first network node. The method may include communicating, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node. The method may include transmitting, to the second network node, an updated configuration that indicates a second set of one or more measurement targets or prediction targets associated with communications between the UE and at least one of the first network node or the second network node.

Some aspects described herein relate to a non-transitory computer-readable medium that stores a set of instructions for wireless communication by a UE. The set of instructions, when executed by one or more processors of the UE, may cause the UE to receive, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The set of instructions, when executed by one or more processors of the UE, may cause the UE to transmit, to the serving network node, a measurement or prediction report including one or more measurements or predictions corresponding to the first set of one or more measurement targets or prediction targets in accordance with the configuration. The set of instructions, when executed by one or more processors of the UE, may cause the UE to receive, from the serving network node, a life cycle management message including an updated configuration that indicates a second set of one or more measurement targets or prediction targets associated with communications between the UE and at least one of the serving network node or the neighbor network node.

Some aspects described herein relate to a non-transitory computer-readable medium that stores a set of instructions for wireless communication by a serving network node. The set of instructions, when executed by one or more processors of the serving network node, may cause the serving network node to transmit, to a UE, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The set of instructions, when executed by one or more processors of the serving network node, may cause the serving network node to receive, from the UE, a measurement or prediction report including one or more measurements or predictions corresponding to the first set of one or more measurement targets or prediction targets in accordance with the configuration. The set of instructions, when executed by one or more processors of the serving network node, may cause the serving network node to transmit, to the UE, a life cycle management message including an updated configuration that indicates a second set of one or more measurement targets or prediction targets associated with communications between the UE and at least one of the serving network node or the neighbor network node.

Some aspects described herein relate to a non-transitory computer-readable medium that stores a set of instructions for wireless communication by a first network node. The set of instructions, when executed by one or more processors of the first network node, may cause the first network node to communicate, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node. The set of instructions, when executed by one or more processors of the first network node, may cause the first network node to transmit, to the second network node, an updated configuration that indicates a second set of one or more measurement targets or prediction targets associated with communications between the UE and at least one of the first network node or the second network node.

Some aspects described herein relate to an apparatus for wireless communication. The apparatus may include means for receiving, from a serving network node, a configuration for predicting one or more parameters associated with UE mobility, wherein the configuration indicates a first set of one or more measurement targets or prediction targets including at least one measurement or prediction target associated with communications between the apparatus and at least one of the serving network node or a neighbor network node. The apparatus may include means for transmitting, to the serving network node, a measurement or prediction report including one or more measurements or predictions corresponding to the first set of one or more measurement targets or prediction targets in accordance with the configuration. The apparatus may include means for receiving, from the serving network node, a life cycle management message including an updated configuration that indicates a second set of one or more measurement targets or prediction targets associated with communications between the apparatus and at least one of the serving network node or the neighbor network node.

Some aspects described herein relate to an apparatus for wireless communication. The apparatus may include means for transmitting, to a UE, a configuration for predicting one or more parameters associated with UE mobility, wherein the configuration indicates a first set of one or more measurement targets or prediction targets including at least one measurement or prediction target associated with communications between the UE and at least one of the apparatus or a neighbor network node. The apparatus may include means for receiving, from the UE, a measurement or prediction report including one or more measurements or predictions corresponding to the first set of one or more measurement targets or prediction targets in accordance with the configuration. The apparatus may include means for transmitting, to the UE, a life cycle management message including an updated configuration that indicates a second set of one or more measurement targets or prediction targets associated with communications between the UE and at least one of the apparatus or the neighbor network node.

Some aspects described herein relate to an apparatus for wireless communication. The apparatus may include means for communicating, with an additional apparatus, a configuration for predicting one or more parameters associated with UE mobility, wherein the configuration indicates a first set of one or more measurement targets or prediction targets including at least one measurement or prediction target associated with communications between a UE and at least one of the apparatus or the additional apparatus. The apparatus may include means for transmitting, to the additional apparatus, an updated configuration that indicates a second set of one or more measurement targets or prediction targets associated with communications between the UE and at least one of the apparatus or the additional apparatus.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings and appendix. Details of one or more implementations of the subject matter described in this disclosure are set forth in the accompanying drawings, the appendix, and the description below. Other features, aspects, and advantages will become apparent from the description, the drawings, and the claims. Note that the relative dimensions of the following figures may not be drawn to scale.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only some aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network.

FIG. 2 is a diagram illustrating an examples of layer 1(L1)/layer 2 (L2) inter-cell mobility.

FIGS. 3 and 4 are diagrams illustrating examples of L1/L2 inter-cell mobility.

FIG. 5 is a diagram illustrating an example of an L1/L2 triggered mobility procedure.

FIG. 6 is a diagram of an example associated with functionality reporting for predictive beam management.

FIG. 7 is a diagram of an example associated with life cycle management signaling for artificial intelligence or machine learning based mobility.

FIG. 8 is a diagram of an example associated with serving network-node-side monitoring or measurement.

FIG. 9 is a diagram of an example associated with neighbor network-node-side monitoring or measurement.

FIG. 10 is a diagram of an example associated with user equipment (UE)-side monitoring or measurement.

FIG. 11 is a diagram illustrating an example architecture of a functional framework for radio access network intelligence enabled by data collection.

FIG. 12 is a diagram illustrating an example process performed, for example, at a UE or an apparatus of a UE.

FIG. 13 is a diagram illustrating an example process performed, for example, at a serving network node or an apparatus of a serving network node.

FIG. 14 is a diagram illustrating an example process performed, for example, at a first network node or an apparatus of a first network node.

FIG. 15 is a diagram of an example apparatus for wireless communication.

FIG. 16 is a diagram of an example apparatus for wireless communication.

### DETAILED DESCRIPTION

Beam management in wireless communication systems involves the selection, measurement, and reporting of beams to enhance signal quality and maintain reliable communication links. In this context, user equipment (UE) devices are tasked with measuring specific beams from serving cells and neighboring cells, predicting the quality or performance of other beams, and reporting relevant information to the network. These measurements and predictions are essential for enabling advanced beamforming techniques, enhancing mobility management, and supporting seamless handovers between cells.

Some beam management methods rely on the UE performing physical layer measurements, such as reference signal received power (RSRP) and channel state information (CSI), over a subset of beams. The UE may then predict the performance of a larger set of beams based on the measurements of a smaller subset. This approach often involves reporting only the “top-performing” beams (e.g., Top-K or Top-1 beams) to the network, which reduces payload size and communication overhead over the uplink control information (UCI) channel. While effective for managing overhead, this method may limit the network's ability to make fully informed decisions regarding beam selection, prediction accuracy, and overall resource allocation.

Mobility use cases in wireless networks expand the scope of beam prediction to include broader spatial and temporal dimensions, as well as cell-level measurement prediction. For example, mobility management incorporates prediction of multiple cells across intra-frequency or inter-frequency ranges, prediction of events such as handover failures (HOFs) or radio link failures (RLFs), and the use of AI/ML-based models to enhance these predictions. Unlike beam management, mobility management often utilizes higher-layer signaling, such as radio resource control (RRC) messages, to report predictions and measurements. Concerns about payload size are reduced, but new challenges arise in terms of lifecycle management for AI/ML-based models.

One technical challenge arises from the requirement to dynamically update configurations while minimizing disruptions. For example, when the network determines that the performance of certain cells or beams is inadequate, the network may wish to update measurement targets without deactivating the entire configuration. Mechanisms for selective updates allow the UE to continue providing measurements or predictions for high-performing targets while excluding underperforming ones.

Another challenge involves balancing the processing resources of the UE. AI/ML-based inference operations may be computationally intensive, and excessive measurement or prediction targets may strain UE hardware, increase latency, and reduce energy efficiency. Mechanisms are implemented to improve inference configurations based on UE capabilities, network requirements, and the scope of prediction tasks.

Additionally, coordination between serving network nodes and neighboring network nodes introduces further complexity. Decisions regarding updates to measurement or prediction targets may involve input from both the serving node and neighboring nodes. Efficient signaling protocols and decision-making frameworks are required to provide accurate and timely updates to configurations.

Overall, the integration of AI/ML-based models into beam management and mobility use cases introduces several technical challenges, including dynamic configuration updates, efficient use of UE resources, selective activation and deactivation of inference operations, and efficient coordination between network nodes.

Various aspects relate generally to lifecycle management and configuration updates for AI/ML-based mobility and beam management. Some aspects more specifically relate to methods and systems enabling a UE to receive, from a serving network node, a configuration for predicting one or more parameters associated with UE mobility, wherein the configuration indicates a first set of measurement targets or prediction targets, including targets associated with communications between the UE and serving or neighboring network nodes. The UE may transmit measurement or prediction reports for the configured targets and receive lifecycle management messages that update the configuration to add, remove, or modify the targets, thereby facilitating dynamic adaptation of measurement and prediction processes.

In some aspects, the lifecycle management messages may include indications for selective management of measurement targets or prediction targets based on performance metrics. For example, the network may identify underperforming targets and remove them from the configuration while retaining high-performing targets for continued measurement or prediction. Additionally, the UE may transmit indications to the network to add or remove targets based on observed performance metrics or resource constraints. This selective adjustment reduces the need for complete activation or deactivation of inference configurations, enabling more granular and efficient lifecycle management.

Particular aspects of the subject matter described in this disclosure can be implemented to realize one or more of the following advantages. By dynamically updating measurement and prediction configurations based on lifecycle management messages, the described techniques may enhance resource allocation, reduce signaling overhead, and improve prediction accuracy for both beam management and mobility use cases. For example, selective updates allow the network to refine prediction targets without disrupting ongoing configurations, providing that relevant measurements continue to inform mobility decisions while excluding low-performing targets. As a result, the system conserves network resources, processing resources, memory resources, and/or the like.

In some aspects, the described methods may reduce computational burden on the UE by enabling selective activation and deactivation of AI/ML-based inference operations. By transmitting lifecycle management messages based on resource availability and processing capabilities, the UE may conserve energy and processing resources, reduce latency, and enhance operational efficiency. Additionally, dynamic signaling between serving and neighboring network nodes facilitates coordinated decision-making for configuration updates, minimizing unnecessary network signaling and enabling resource-efficient transitions, such as handovers or event predictions.

In further aspects, the integration of AI/ML-based models into beam and mobility management enhances prediction capabilities, enabling more precise spatial and temporal predictions across intra-frequency and inter-frequency ranges. This improves the network's ability to enhance beamforming, mitigate interference, and support advanced mobility scenarios, such as predicting radio link failures (RLFs) or handover failures (HOFs). By leveraging the described techniques, wireless communication systems may achieve greater adaptability, reliability, and spectral efficiency while conserving computational and network resources in complex and dynamic environments.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

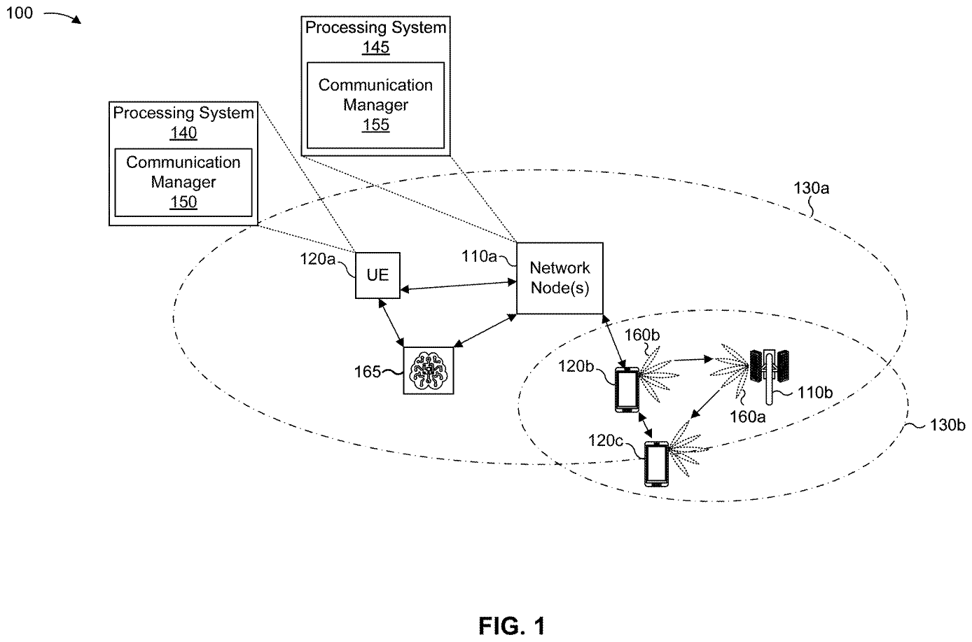

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a service management and orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a global navigation satellite system (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

One enhancement for multi-beam operation at higher carrier frequencies is facilitation of efficient (for example, low latency and low overhead) downlink or uplink beam management operations to support Layer 1 or Layer 2 (L1/L2)-centric inter-cell mobility. L1/L2 signaling may be referred to as “lower layer” signaling. L1/L2 signaling may be used to activate or deactivate candidate cells in a set of cells configured for lower layer triggered mobility (LTM) or to provide reference signals for measurement by the UE 120, by which the UE 120 may select a candidate beam as a target beam for a lower layer handover operation. Accordingly, L1/L2-centric inter-cell mobility may enable a UE 120 to perform a cell switch via dynamic control signaling at lower layers (for example, DCI for L1 signaling or a MAC-CE for L2 signaling), rather than semi-static Layer 3 (L3) RRC signaling. Thus, L1/L2 centric inter-cell mobility may reduce latency, reduce overhead, or otherwise increase efficiency of the cell switch.

In some aspects, the UE 120 may include a communication manager 150. As described in more detail elsewhere herein, the communication manager 150 may receive, from a serving network node 110, a configuration for predicting one or more parameters associated with UE mobility, wherein the configuration indicates a first set of one or more measurement targets or prediction targets including at least one measurement or prediction target associated with communications between the UE 120 and at least one of the serving network node 110 or a neighbor network node 110; transmit, to the serving network node 110, a measurement or prediction report including one or more measurements or predictions corresponding to the first set of one or more measurement targets or prediction targets in accordance with the configuration; and receive, from the serving network node 110, a life cycle management message including an updated configuration that indicates a second set of one or more measurement targets or prediction targets associated with communications between the UE 120 and at least one of the serving network node 110 or the neighbor network node 110. Additionally, or alternatively, the communication manager 150 may perform one or more other operations described herein.

In some aspects, the network node 110 may include a communication manager 155. As described in more detail elsewhere herein, the communication manager 155 may transmit, to a UE 120, a configuration for predicting one or more parameters associated with UE mobility, wherein the configuration indicates a first set of one or more measurement targets or prediction targets including at least one measurement or prediction target associated with communications between the UE 120 and at least one of the serving network node 110 or a neighbor network node 110; receive, from the UE, a measurement or prediction report including one or more measurements or predictions corresponding to the first set of one or more measurement targets or prediction targets in accordance with the configuration; and transmit, to the UE, a life cycle management message including an updated configuration that indicates a second set of one or more measurement targets or prediction targets associated with communications between the UE and at least one of the serving network node 110 or the neighbor network node 110. Additionally, or alternatively, the communication manager 155 may perform one or more other operations described herein.

In some aspects, the network node 110 may include a communication manager 155. As described in more detail elsewhere herein, the communication manager 155 may communicate, with a second network node 110, a configuration for predicting one or more parameters associated with UE mobility, wherein the configuration indicates a first set of one or more measurement targets or prediction targets including at least one measurement or prediction target associated with communications between a UE and at least one of the first network node 110 or the second network node 110; and transmit, to the second network node 110, an updated configuration that indicates a second set of one or more measurement targets or prediction targets associated with communications between the UE and at least one of the first network node 110 or the second network node 110. Additionally, or alternatively, the communication manager 155 may perform one or more other operations described herein.

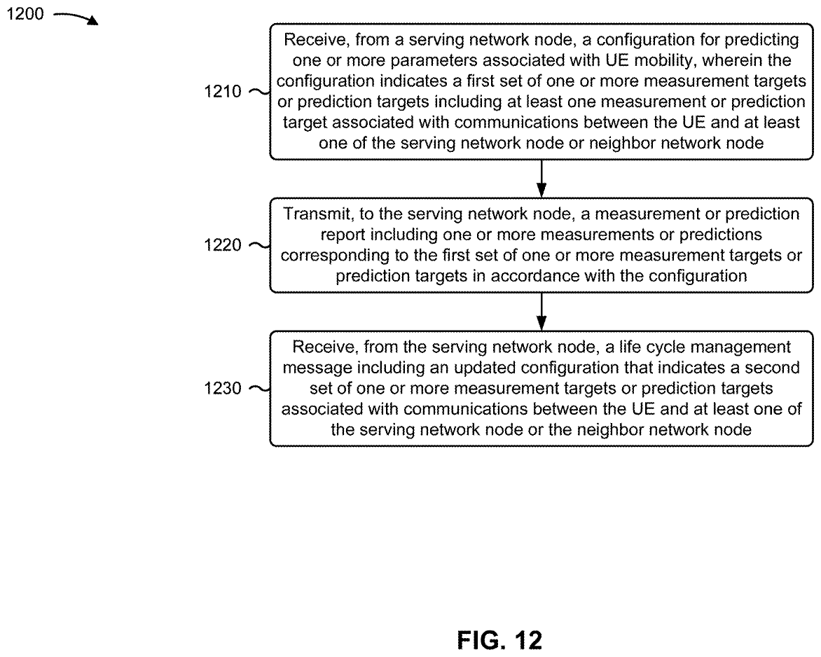

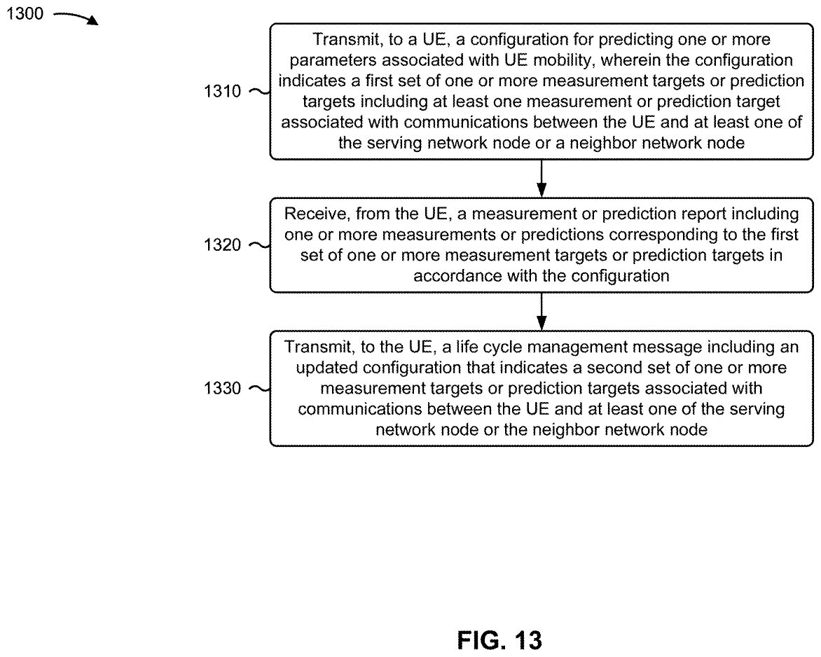

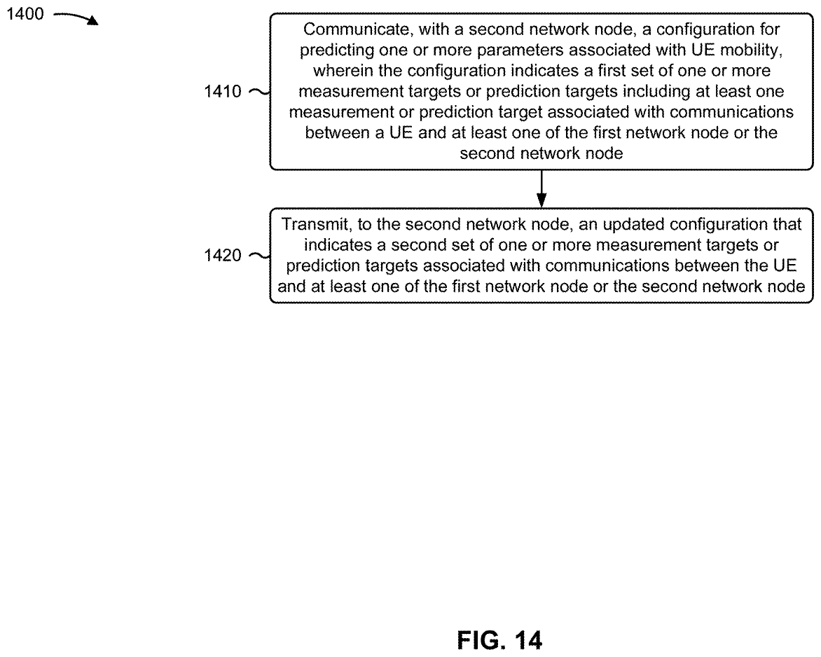

The network node 110, the processing system 145 of the network node 110, the UE 120, the processing system 140 of the UE 120, or any other component(s) of FIG. 1 may implement one or more techniques or perform one or more operations associated with life cycle management signaling for artificial intelligence or machine learning based mobility, as described in more detail elsewhere herein. For example, the processing system 145 of the network node 110, or the processing system 140 of the UE 120 may perform or direct operations of, for example, process 1200 of FIG. 12, process 1300 of FIG. 13, process 1400 of FIG. 14, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 1200 of FIG. 12, process 1300 of FIG. 13, process 1400 of FIG. 14, or other processes as described herein. In some examples, executing instructions may include running the instructions, converting the instructions, compiling the instructions, or interpreting the instructions, among other examples.

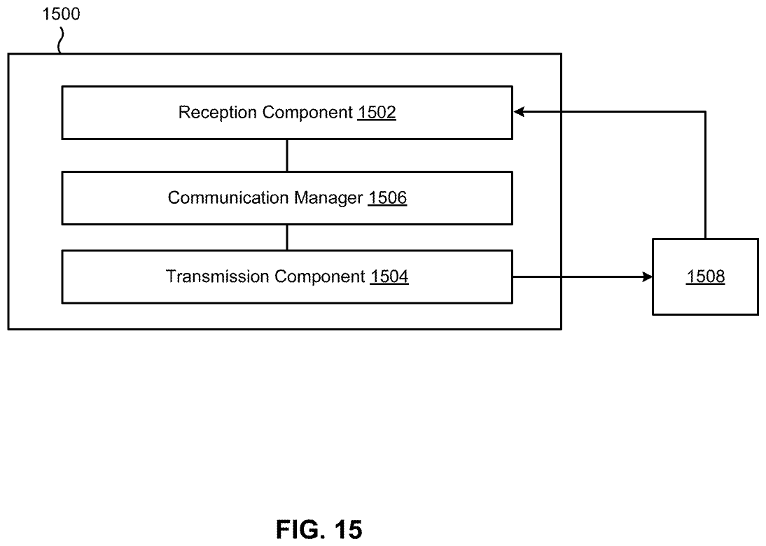

In some aspects, the 120 includes means for receiving, from a serving network node 110, a configuration for predicting one or more parameters associated with UE mobility, wherein the configuration indicates a first set of one or more measurement targets or prediction targets including at least one measurement or prediction target associated with communications between the UE 120 and at least one of the serving network node 110 or the neighbor network node 110; means for transmitting, to the serving network node 110, a measurement or prediction report including one or more measurements or predictions corresponding to the first set of one or more measurement targets or prediction targets in accordance with the configuration; or means for receiving, from the serving network node 110, a life cycle management message including an updated configuration that indicates a second set of one or more measurement targets or prediction targets associated with communications between the UE 120 and at least one of the serving network node 110 or the neighbor network node 110. The means for the UE to perform operations described herein may include, for example, one or more of communication manager 150, processing system 140, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

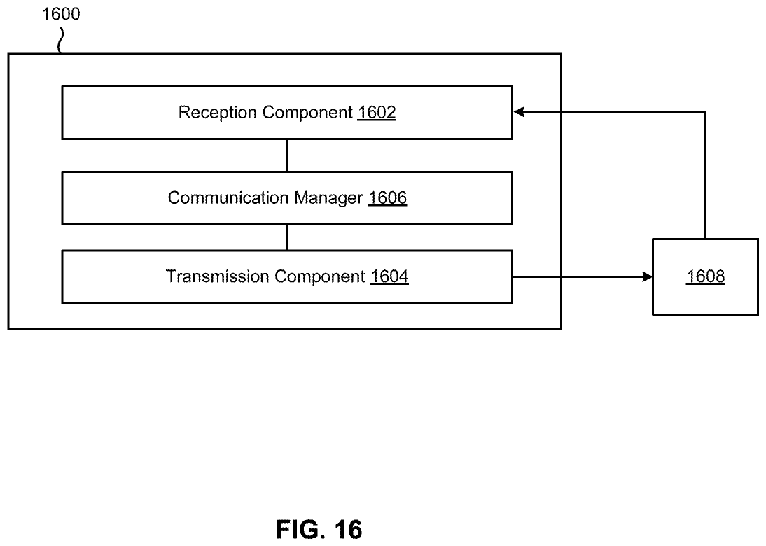

In some aspects, the serving network node 110 includes means for transmitting, to a UE 120, a configuration for predicting one or more parameters associated with UE mobility, wherein the configuration indicates a first set of one or more measurement targets or prediction targets including at least one measurement or prediction target associated with communications between the UE 120 and at least one of the serving network node 110 or a neighbor network node 110; means for receiving, from the UE 120, a measurement or prediction report including one or more measurements or predictions corresponding to the first set of one or more measurement targets or prediction targets in accordance with the configuration; or means for transmitting, to the UE 120, a life cycle management message including an updated configuration that indicates a second set of one or more measurement targets or prediction targets associated with communications between the UE 120 and at least one of the serving network node 110 or the neighbor network node 110. The means for the serving network node 110 to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

In some aspects, the first network node 110 includes means for communicating, with a second network node 110, a configuration for predicting one or more parameters associated with UE mobility, wherein the configuration indicates a first set of one or more measurement targets or prediction targets including at least one measurement or prediction target associated with communications between a UE 120 and at least one of the first network node 110 or the second network node 110; or means for transmitting, to the second network node 110, an updated configuration that indicates a second set of one or more measurement targets or prediction targets associated with communications between the UE 120 and at least one of the first network node 110 or the second network node 110. The means for the first network node to perform operations described herein may include, for example, one or more of communication manager 155, processing system 145, a radio, one or more RF chains, one or more transceivers, one or more antennas, one or more modems, a reception component (for example, reception component 1602 depicted and described in connection with FIG. 16), or a transmission component (for example, transmission component 1604 depicted and described in connection with FIG. 16), among other examples.

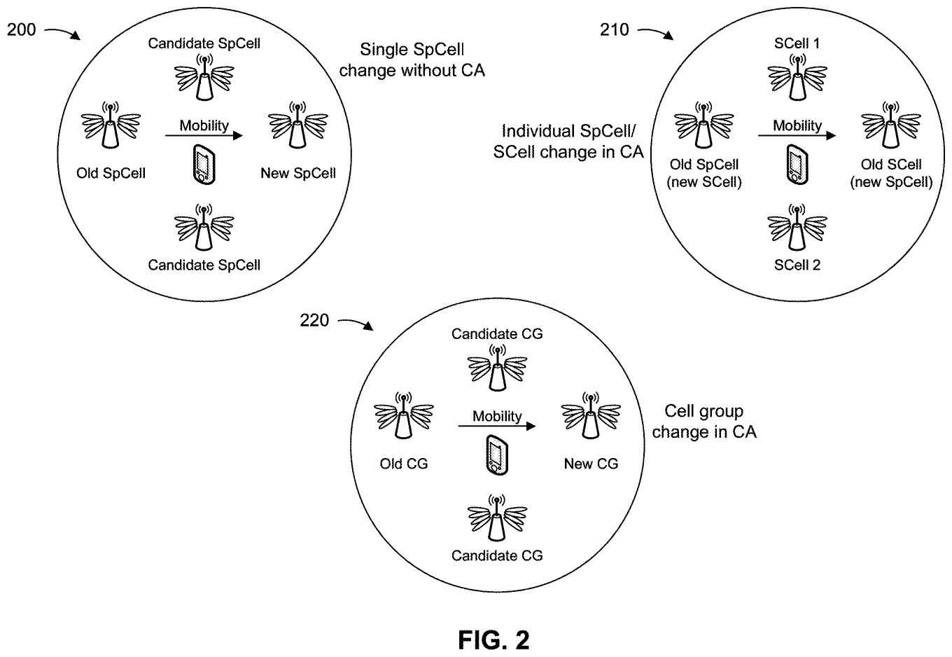

FIG. 2 is a diagram illustrating an examples 200, 210, and 220 of L1/L2 inter-cell mobility.

In some aspects, as described herein, examples 200, 210, 220 relate to different scenarios in which L1 signaling (e.g., a DCI message) or L2 signaling (e.g., a MAC-CE) is used to indicate a change to a serving cell or a serving cell group (e.g., changing from a source cell to a target cell). For example, as described in further detail herein, examples 200, 210, 220 generally relate to different scenarios in which L1/L2 signaling may be used to dynamically switch among candidate serving cells (e.g., including a special cell (SpCell), which may be a primary cell (PCell) or a primary secondary cell (PSCell), or a secondary cell (SCell)).

As shown in FIG. 2, and by example 200, a network node may configure the UE with a candidate SpCell set that includes various candidate SpCells to enable individual SpCell selection in a first L1/L2 inter-cell mobility scenario where separate signaling is used to indicate a SpCell change without carrier aggregation or dual connectivity. For example, the UE may be communicating with a source SpCell (shown as an old SpCell), and the serving SpCell may be switched to a target SpCell (shown as a new SpCell) that corresponds to a candidate SpCell included in the candidate SpCell set. Accordingly, in example 200, L1/L2 signaling may be used to select a single SpCell among various candidate SpCells in a preconfigured candidate SpCell set without carrier aggregation or dual connectivity (e.g., the candidate SpCell set does not include any SCells). In this case, the new SpCell may be selected based on a beam indication, and selection of an SCell may be based on legacy (e.g., L3) signaling or separate L1/L2 signaling. Additionally, or alternatively, as shown by example 210, the UE may be configured with a candidate SpCell set, and a SpCell may be changed from a source cell to a target cell by swapping roles of a SpCell and an SCell among the cells included in the candidate SpCell set (e.g., in a carrier aggregation or dual connectivity scenario). For example, as shown by example 210 in FIG. 2, a current SpCell may be swapped with a current SCell such that the old SpCell becomes a new SCell and the old SCell becomes the new SpCell. Additionally, or alternatively, as shown by example 220, the UE may be configured with a candidate cell group, which may enable an SpCell (e.g., a PCell or a PSCell) and an SCell to be switched together in a carrier aggregation or dual connectivity scenario. For example, in this case, a cell group including multiple cells can be activated or deactivated together using L1/L2 signaling, where a current serving cell may be selected from a current cell group and the current serving cell may be selected from a new cell group based on mobility of the UE. In this case, the L1/L2 signaling used to change the cell group may be similar to examples 200 and 210, except that the L1/L2 signaling is used to switch cell groups that may include multiple cells rather than individual cells.

In general, in examples 200, 210, 220, the L1/L2 signaling that is used to switch the serving cell for the UE may be based on one or more L1 measurements that are obtained and reported by the UE. For example, a network node may configure the UE to obtain an L1-RSRP measurement, an L1-RSRQ measurement, an L1-SINR measurement, or other suitable intra-frequency or inter-frequency measurements for one or more candidate cells (e.g., target cells, candidate SpCells or candidate SCells), and the UE may transmit an L1 report that includes the L1 measurements to the network node to enable L1/L2 inter-cell mobility.

In some examples, L1/L2 inter-cell mobility may be triggered preemptively by inferring or predicting one or more conditions for triggering a mobility procedure by implementing AI/ML based mobility predictions. In some examples, a UE or the network may perform cell-level measurement prediction, which may be an extension of beam level measurement prediction to cell level measurement prediction for serving and candidate cells. For example, UE-side models or network-side models may perform measurement event prediction, or RLF prediction or handover failure prediction, among other examples.

In some examples, AI/ML models have been used for single cell beam prediction. For example, an AI/ML model may be used for spatial downlink beam prediction for set-A beams based on measurement results of set-B beams (e.g., where set-B beams are wide beams, while set-A beams are narrow beams; where set-B beams are narrow beams, while Set-A beams are other narrow beams). In another example, an AI/ML model may be used for temporal downlink beam prediction for set-A beams based on the historic measurement results of set-B beams (e.g., where set-A and set-B beams are the same (pure temporal beam prediction); where set-A and set-B beams are different (spatial+temporal beam prediction)).

As indicated above, FIG. 2 is provided as an example. Other examples may differ from what is described with regard to FIG. 2.

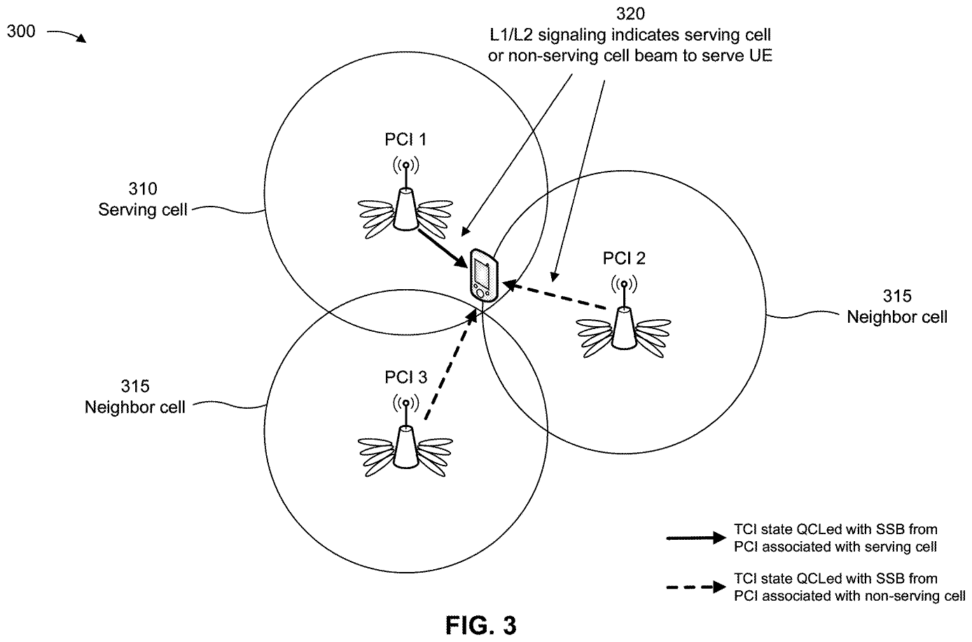

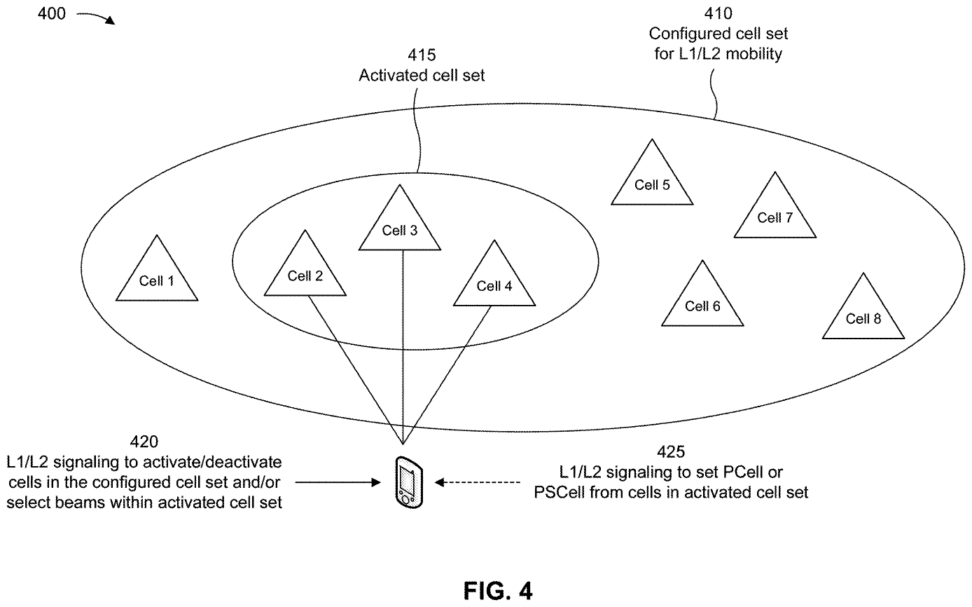

FIGS. 3 and 4 are diagrams illustrating examples 300 and 400 of L1/L2 inter-cell mobility.

In a wireless network, a UE and a network node may communicate on an access link using directional links (e.g., using high-dimensional phased arrays) to benefit from a beamforming gain or to maintain acceptable communication quality. The directional links, however, typically require fine alignment of transmit and receive beams, which may be achieved through a set of operations referred to as beam management or beam selection, among other examples. Further, a wireless network may support multi-beam operation at relatively high carrier frequencies (e.g., within FR2 or FR4), which may be associated with harsher propagation conditions than comparatively lower carrier frequencies. For example, relative to a sub-6 gigahertz (GHz) band (e.g., FR1), signals propagating in a millimeter wave frequency band may suffer from increased pathloss and severe channel intermittency, or may be blocked by objects commonly present in an environment surrounding the UE (e.g., a building, a tree, or a body of a user, among other examples). Accordingly, beam management is particularly important for multi-beam operation in a relatively high carrier frequency.

One possible enhancement for multi-beam operation at higher carrier frequencies is facilitation of efficient (e.g., low latency and low overhead) downlink or uplink beam management to support higher L1/L2-centric inter-cell mobility. Accordingly, one goal for L1/L2-centric inter-cell mobility is to enable a UE to perform a cell switch via dynamic control signaling at lower layers (e.g., DCI for L1 signaling or a MAC control element (MAC-CE) for L2 signaling) rather than semi-static Layer 3 (L3) RRC signaling to reduce latency, reduce overhead, or otherwise increase efficiency of the cell switch.

For example, FIG. 3 illustrates an example 300 of a first L1/L2 inter-cell mobility technique, which may be referred to as beam-based inter-cell mobility, dynamic point selection based inter-cell mobility, or non-serving cell-based inter-cell mobility, among other examples. As described in further detail herein, the first L1/L2 inter-cell mobility technique may enable a network node to use L1 signaling (e.g., DCI) or L2 signaling (e.g., a MAC-CE) to indicate that a UE is to communicate on an access link using a beam from a serving cell or a non-serving cell. For example, in a wireless network where L1/L2 inter-cell mobility is not supported (e.g., cell switches are triggered only by an L3 handover), beam selection for control information and for data is typically limited to beams within a physical cell identity (PCI) associated with a serving cell. In contrast, in a wireless network that supports the first L1/L2 inter-cell mobility technique (e.g., as shown in FIG. 3), beam selection for control and data may be expanded to include any beams within a serving cell 310 or one or more non-serving neighbor cells 315 configured for L1/L2 inter-cell mobility.

For example, in the first L1/L2 inter-cell mobility technique shown in FIG. 3, a UE may be configured with a single serving cell 310, and may be further configured with a neighbor cell set that includes one or more non-serving cells 315 configured for L1/L2 inter-cell mobility. In general, the serving cell 310 and the non-serving cell(s) 315 configured for L1/L2 inter-cell mobility may be associated with a common CU and a common DU, or the serving cell 310 and the non-serving cell(s) 315 configured for L1/L2 inter-cell mobility may be associated with a common CU and different DUs. In some aspects, as shown by reference number 320, a network node may trigger L1/L2 inter-cell mobility for a UE using L1/L2 signaling (e.g., DCI or a MAC-CE) that indicates a selected transmission configuration indication (TCI) state quasi co-located (QCL'ed) with a reference signal (e.g., a synchronization signal block (SSB)) associated with a PCI. For example, in FIG. 3, the UE may be communicating with the serving cell 310 using a TCI state that is QCL'ed with an SSB from a PCI associated with the serving cell 310 (e.g., shown as PCI 1 in FIG. 3), and L1/L2 signaling may trigger inter-cell mobility by indicating that the UE is to switch to communicating using a TCI state that is QCL'ed with an SSB from a PCI associated with a non-serving neighbor cell 315 (e.g., shown as PCI 2 in FIG. 3). Accordingly, in the first L1/L2 inter-cell mobility technique, the network node (e.g., the common CU controlling the serving cell 310 and the non-serving neighbor cell(s) 415) may use L1/L2 signaling to select a beam from either the serving cell 310 or a non-serving neighbor cell 315 to serve the UE.

As a result, relative to restricting L1/L2 beam selection to beams within the serving cell 310, the first L1/L2 inter-cell mobility technique may be more robust against blocking and may provide more opportunities for higher rank spatial division multiplexing across different cells. However, the first L1/L2 inter-cell mobility technique does not enable support for changing a special cell (SpCell) for a UE, where an SpCell may be a primary cell (PCell) or a primary secondary cell (PSCell). Rather, in the first L1/L2 inter-cell mobility technique, triggering an SpCell change is performed via a legacy L3 handover using RRC signaling. In this respect, the first L1/L2 inter-cell mobility technique is associated with a limitation in that L1/L2 signaling can only be used to indicate a beam from the serving cell 310 or a configured neighbor cell 315 while the UE is in the coverage area of the serving cell 310 (e.g., because L1/L2 signaling cannot be used to change the PCell or PSCell).

The inter-cell mobility techniques described herein may be preemptively triggered by spatial beam prediction including serving beam or serving cell prediction. For example, the UE may measure beams from the serving cell to predict the beams of that serving cell. In another example, the UE may measure beams from both the serving cell and neighboring cells to predict the beams of the serving cell.

Intra-frequency beam or cell prediction offers several strategies for prediction across multiple cells within the same frequency. In a first example, the UE may predict beams across multiple cells within the same frequency range. In another example, the UE may measure a few beams from the predicted cell to forecast other beams within that cell. In another example, the UE may measure at least a few beams from a serving cell and neighboring cells to predict the radio measurements of other beams within that cell. In another example, the UE may not need to measure beams from a cell to predict beams when the UE can utilize measurements from beams of other cells.

Inter-frequency beam or cell prediction expands the scope to include multiple frequencies. In one example, the UE may measure and predict beams across one or more frequencies. In another example, the UE may measure and predict beams across multiple cells within the inter-frequency list or range. In another example, the UE may measure a few beams on the predicted cell frequency, non-predicted cells on the same frequency, and non-predicted cells on other frequencies to predict other beams of the cell. In another example, the UE may not need to measure beams of a predicted cell but requires measurements from a few beams of the predicted cell frequency and non-predicted cell frequencies to predict beams of that cell. In another example, the UE may predict beams of a cell without measuring beams on the same frequency, using measurements from other cells on any inter-frequency.

Temporal beam or cell prediction combines spatial predictions with multiple instances to enhance prediction accuracy over time. Additionally, event prediction, such as A1-A6 events, may be achieved using temporal cell or beam prediction or direct prediction methods. Predicting these events may help manage handovers and signal quality thresholds, improving connectivity and enhancing performance in dynamic wireless environments.

FIG. 4 illustrates an example 400 of a second L1/L2 inter-cell mobility technique, which may be referred to as serving cell-based inter-cell mobility, among other examples. As described in further detail herein, the second L1/L2 inter-cell mobility technique may enable a network node to use L1/L2 signaling (e.g., DCI or a MAC-CE) to indicate control information associated with an activated cell set or a deactivated cell set or to indicate a change to an SpCell within the activated cell set.

For example, as shown in FIG. 4, the second L1/L2 inter-cell mobility technique may use mechanisms that are generally similar to carrier aggregation to enable L1/L2 inter-cell mobility, except that different cells configured for L1/L2 inter-cell mobility may be on the same carrier frequency. As shown in FIG. 4, a network node may configure a cell set 410 for L1/L2 inter-cell mobility (e.g., using RRC signaling). As further shown, an activated cell set 415 may include one or more cells in the configured cell set 410 that are activated and ready to use for data or control transfer. Accordingly, in the second L1/L2 inter-cell mobility technique, a deactivated cell set may include one or more cells that are included in the cell set 410 configured for L1/L2 inter-cell mobility but are not included in the activated cell set 415. However, the cells that are included in the deactivated cell set can be readily activated, and thereby added to the activated cell set 415, using L1/L2 signaling. Accordingly, as shown by reference number 420, L1/L2 signaling can be used for mobility management of the activated cell set 415. For example, in some aspects, L1/L2 signaling can be used to activate cells within the configured cell set 410 (e.g., to add cells to the activated cell set 415), to deactivate cells in the activated cell set 415, or to select beams within the cells included in the activated cell set 415. As a result, the second L1/L2 inter-cell mobility technique may enable seamless mobility among the cells included in the activated cell set 415 using L1/L2 signaling (e.g., using beam management techniques).

Furthermore, as shown by reference number 425, the second L1/L2 inter-cell mobility technique enables using L1/L2 signaling to set or change an SpCell (e.g., a PCell or PSCell) from the cells included in the activated cell set 415. Additionally, or alternatively, when the cell to become the new SpCell is in the deactivated cell set (e.g., is included in the cell set 410 configured for L1/L2 mobility but not the activated cell set 415), L1/L2 signaling can be used to move the cell from the deactivated cell set to the activated cell set 415 before further L1/L2 signaling is used to set the cell as the new SpCell. However, in the second L1/L2 inter-cell mobility technique, an L3 handover (e.g., using RRC signaling) is used to change the SpCell when the new SpCell is not included in the cell set 410 configured for L1/L2 inter-cell mobility. In such cases, RRC signaling associated with the L3 handover may be used to update the cells included in the cell set 410 configured for L1/L2 inter-cell mobility. Accordingly, L1/L2 inter-cell mobility can provide more efficient cell switching to support multi-beam operation, enabling lower latency and reduced overhead by using L1 signaling (e.g., DCI) or L2 signaling (e.g., a MAC-CE) rather than L3 signaling (e.g., RRC) to change the beam(s) that a UE uses to communicate over an access link.

The beams used to communicate over an access link may be predicted, in some examples, according to a UE-side inference configuration. For example, the configuration may include a same identifier (e.g., measObjectID) for both set-A beams and set-B beams; or a single configuration (e.g., measObjectNR) may include the configuration for both set-A beams and set-B beams; or the configuration may include an indicator or separate information elements (e.g., within the measObjectNR) for indicating measurement and prediction objects.

In some other examples, the configuration may include an identifier for set-A beams and another identifier for set-B beams (e.g., two measObjectIDs), which may result in NBC to MeasIDToAddMod; a new MeasIDxyzToAddMod information element for RRM prediction; or both measObjectIds in the MeasIDxyzToAddMod.

In some other examples, the configuration may include an identifier for set-A beams and another identifier for set-B beams (e.g., two measObjectIDs); and MeasResult may include two measIDs (e.g., one for set-A beams and another for set-B beams).

As indicated above, FIGS. 3 and 4 are provided as examples. Other examples may differ from what is described with regard to FIGS. 3 and 4.

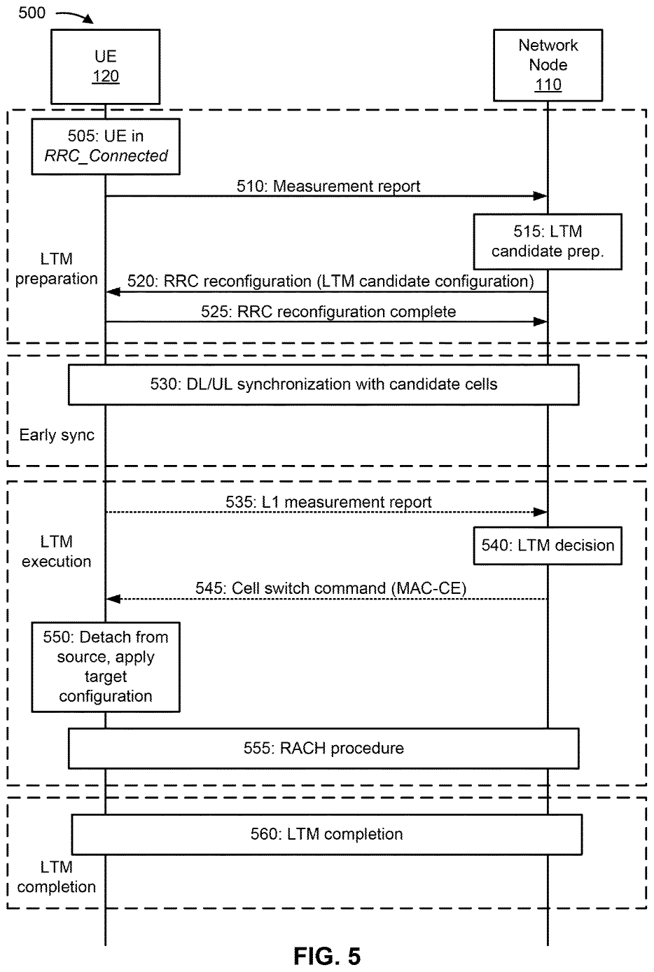

FIG. 5 is a diagram illustrating an example 500 of a Layer 1/Layer 2 (L1/L2) triggered mobility (LTM) procedure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages or other L3 signaling and operations used to perform the handover procedures. Accordingly, in some examples, a UE 120 may be configured to perform a lower-layer (e.g., L1 or L2) handover procedure, sometimes referred to an LTM procedure, such as the example 500 LTM procedure shown in FIG. 5. As shown in FIG. 5, the LTM procedure may include four phases: an LTM preparation phase, an early synchronization phase (shown as “early sync” in FIG. 5), an LTM execution phase, or an LTM completion phase.

During the LTM preparation phase, and as shown by reference number 505, the UE 120 may be in an RRC connected state (sometimes referred to as RRC_Connected) with a source cell. As shown by reference number 510, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, or CQI) or similar measurements associated with the source cell or one or more neighboring cells. In some examples, based at least in part on the measurement report or other information, the network node 110 may decide to use LTM, and thus, as shown by reference number 515, the network node 110 may initiate LTM candidate preparation.

As shown by reference number 520, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE or cells for which the UE 120 may later be triggered to perform an LTM procedure. As shown by reference number 525, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as shown by reference number 530, the UE 120 may optionally perform downlink/uplink synchronization with the candidate cells associated with the one or more LTM candidate cell configurations. For example, the UE 120 may perform downlink synchronization and timing advance acquisition with the one or more candidate target cells prior to receiving an LTM switch command (which is described in more detail below in connection with reference number 555). In some aspects, performing the early synchronization with the one or more candidate cells may reduce latency associated with performing a random access channel (RACH) procedure later in the LTM procedure, which is described in more detail below in connection with reference number 555.

During the LTM execution phase, and as shown by reference number 535, the UE 120 may perform L1 measurements on the configured LTM candidate target cells, and thus may transmit, to the network node 110, lower-layer (e.g., L1) measurement reports. As shown by reference number 540, based at least in part on the lower-layer measurement reports, the network node 110 may decide to execute an LTM cell switch to a target cell. Accordingly, as shown by reference number 545, the network node 110 may transmit, and the UE 120 may receive, a MAC control element (MAC-CE) or similar message triggering an LTM cell switch (the MAC-CE or similar message is sometimes referred to herein as a cell switch command). The cell switch command may include an indication of a candidate configuration index associated with the target cell. As shown by reference number 550, based at least in part on receiving the cell switch command, the UE 120 may switch to the configuration of the LTM candidate target cell (e.g., the UE 120 may detach from the source cell and apply the target cell configuration). Moreover, as shown by reference number 555, the UE 120 may perform a RACH procedure towards the target cell, such as when a timing advance associated with the target cell is not available (e.g., in examples in which the UE 120 did not perform the early synchronization as described above in connection with reference number 530).

During the LTM completion phase, and as shown by reference number 560, the UE 120 may indicate successful completion of the LTM cell switch towards the target cell. As a result, cell switch to a target cell may be performed using less overhead than for an L3 handover procedure or a cell switch to a target cell may be associated with reduced latency as compared to L3 handover procedure.

In some examples, the LTM procedure described with reference to FIG. 5 may be triggered or may incorporate one or more aspects of AI/ML-based mobility. The UE 120 may be configured to report prediction of all configured cells and beams, and thus there may be some instances where the UE predicts a large quantity of beams, but because the reporting is performed by RRC, the large report may not cause issues related to overhead. However, the network mode may verify whether predictions for the top K beams or the top beam are accurate. When the predictions are not accurate, the network may activate or deactivate the inference model.

As indicated above, FIG. 5 is provided as an example. Other examples may differ from what is described with respect to FIG. 5.

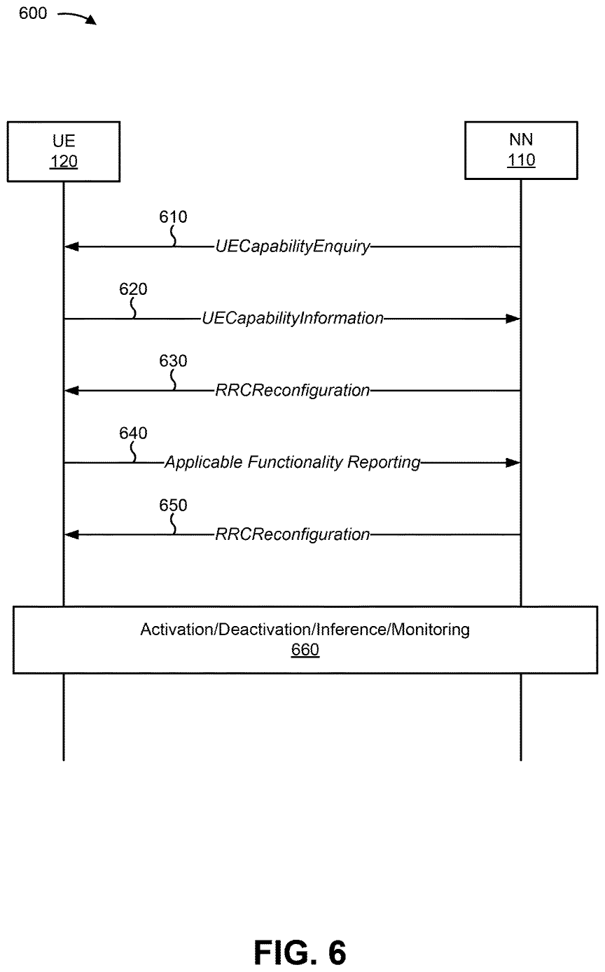

FIG. 6 is a diagram of an example 600 associated with functionality reporting for AI/ML beam management. As shown in FIG. 6, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 6.

As shown by reference number 610, the network node 110 may transmit, and the UE 120 may receive, a UE capability enquiry message. For example, the network node may send a UECapabilityEnqiry message to trigger the UE reporting AI/ML supported functionalities. In some examples, AI/ML supported functionalities may include an AI/ML-based measurement functionality, an AI/ML-based prediction functionality, a quantity of beams, cells, or entities the UE is capable of measuring or predicting, among other examples. In some examples, UECapabilityEnqiry message to trigger the UE reporting other supported functionalities for algorithm-based or inference model-based inference, prediction, or measurement.

As shown by reference number 620, the UE 120 may transmit, and the network node 110 may receive, UE capability information. For example, the UE may transmit a UECapabilityInformation message to the network node, indicating supported AI/ML functionalities at the UE.

As shown by reference number 630, the network node 110 may transmit, and the UE 120 may receive, an RRC reconfiguration message. For example, the network node 110 may provide the following configurations to the UE 120 via the RRC reconfiguration message: a UE assistance information (UAI) reporting configuration via OtherConfig; one or more network-side conditions or configurations.

Between reference number 630 and reference number 640, the UE 120 may identify one or more applicable AI/ML functionalities based on network-side additional conditions (e.g., when provided), one or more UE-side additional conditions (e.g., internally available to the UE), or model availability at the UE.

As shown by reference number 640, the UE 120 may transmit, and the network node 110 may receive, functionality reporting. For example, the UE 120 may report applicable functionality in the following scenarios: (1) upon being configured to provide applicable functionality and upon change of applicable functionality via UAI; or (2) as a response to network-side additional conditions requesting applicable functionality reporting, described in connection with reference number 630.

As shown by reference number 650, the network node 110 may transmit, and the UE 120 may receive, an RRC reconfiguration message. For example, the network node 110 may configure an inference configuration for the UE 120 in response to the applicable functionality reporting, for example, when the inference configuration based on supported functionality is not provided via the RRC reconfiguration message described in connection with reference number 630. When the inference configuration based on supported functionality is provided via the RRC reconfiguration message described in connection with reference number 630, providing the updated configuration may be up to network implementation.

As shown by reference number 660, the UE 120 and the network node 110 may perform activation or deactivation in inference or performance metric monitoring. For example, the applicable AI/ML functionalities may be activated by receiving the inference configuration described in connection with reference number 650.

In the context of beam management, a CSI report configuration (e.g., CSI-ReportConfig) may be activated or deactivated (e.g., using L1/L2/L3 signaling) according to the applicability of the configuration or performance of inference operations.

When the applicable AI/ML functionalities are activated, the UE 120 may be configured to report prediction of all configured cells and beams, and thus there may be some instances where the UE predicts a large quantity of beams, but because the reporting is performed by RRC, the large report may not cause issues related to overhead. However, the network mode may verify whether predictions for the top K beams or the top beam are accurate. When the predictions are not accurate, the network may activate or deactivate the inference model. For example, when the UE 120 is configured to predict measurements of cells C:{C₁, C₂, . . . , C_{N}}, and the network node 110 determines that performance of cells C′={C_{K}, C_{K+1}, . . . , C_{L}} falls below a signal quality threshold, then the network node 110 may deactivate the inference configuration.

As indicated above, FIG. 6 is provided as an example. Other examples may differ from what is described with respect to FIG. 6.

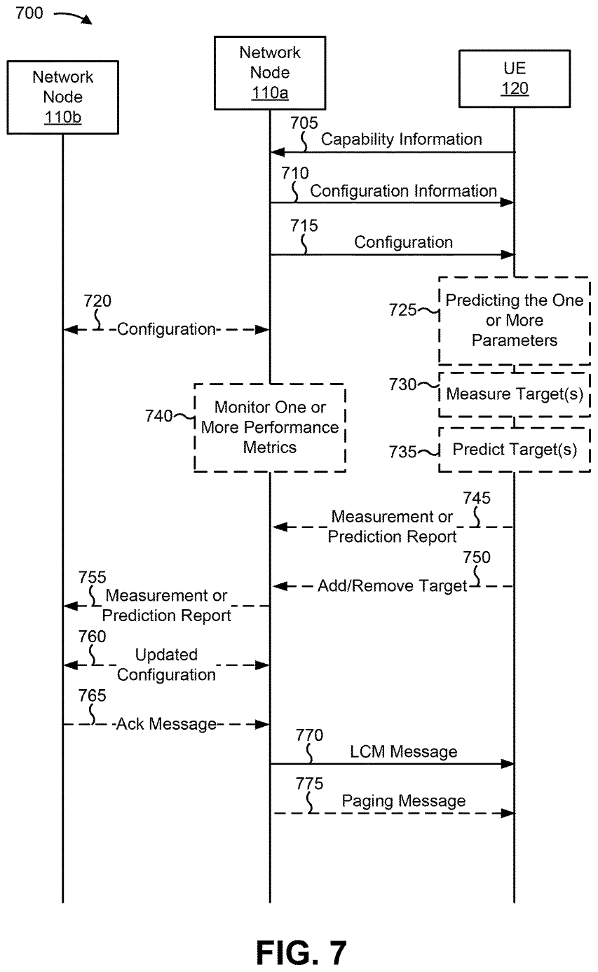

FIG. 7 is a diagram of an example 700 associated with life cycle management signaling for artificial intelligence or machine learning based mobility. As shown in FIG. 7, a network node 110a and a network node 110b (e.g., a base station, a CU, a DU, or an RU) may communicate with a UE 120. In some aspects, the network node 110a, the network node 110b, and the UE 120 may be part of a wireless network (e.g., the wireless communication network 100). The UE 120 and the network node 110a may have established a wireless connection prior to operations shown in FIG. 7. FIG. 7 depicts an example sequence of operations associated with the transmission and reception of capability information and/or configuration information to enable the UE 120 to predict serving cell beams based on measurements from neighboring cell beams, as well as to receive configurations for predicting mobility parameters, ensuring stable communication during mobility events through improved measurement and prediction targets, and facilitating seamless transitions between network nodes 110 by sharing prediction reports and coordinating beam configurations.

In some aspects, as shown by reference number 705, the UE 120 may transmit, and the network node 110a may receive, capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for predicting serving cell beams based on measurements from neighboring cell beams. As another example, the capability information may indicate a capability or parameter for model training and inference, including network-side resources for RRM prediction and UE-side models for spatial, temporal, and event prediction. One or more operations described herein may be based on capability information. For example, the UE 120 may perform a communication in accordance with the capability information, or may receive configuration information that is in accordance with the capability information. In some aspects, the capability information may indicate UE support for spatial prediction strategies, intra-frequency prediction, inter-frequency prediction, AI/ML-based mobility inference configurations, and capability exchange and reporting for beam management.

The UE 120 may transmit a capability information message indicating one or more supported prediction or measurement functionalities. For example, the UE 120 may send a message listing capabilities to predict serving cell beams based on measurements from neighboring cell beams. As a result, transmitting a capability information message may allow the network to improve the configuration for the UE prediction tasks.

In some aspects, different sub-use cases and options for model training and inference may be available, including network-side models for RRM prediction and UE-side models for spatial, temporal, and event prediction. For example, the UE 120 may leverage network-side resources for spatial beam prediction while using local models for temporal prediction. Providing flexible training and inference options may enhance the adaptability of UE prediction capabilities.

As shown by reference number 710, the network node 110a may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node 110a or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110a may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may indicate that the UE 120 is to transmit a capability information message indicating one or more supported prediction or measurement functionalities. For example, the UE 120 may send a message listing capabilities to predict serving cell beams based on measurements from neighboring cell beams. This capability signaling allows the network to tailor the configuration for the UE prediction tasks according to the UE capability. Additionally, the UE 120 may receive configurations for predicting parameters associated with UE mobility, which may include a set of measurement or prediction targets related to communications with the serving network node 110a or the neighboring network node 110b. The UE 120 may measure and predict these targets to maintain stable communication during mobility events. Moreover, detailed prediction configurations may provide various strategies for spatial, intra-frequency, inter-frequency, and temporal beam or cell predictions, enabling improved network resource utilization. The configuration information may also involve signaling for life cycle management, including reconfiguration, activation, or deactivation of inference configurations based on monitoring results or UE requests, ensuring timely adaptation to evolving mobility needs.

The UE 120 may configure itself based at least in part on the configuration information. In some aspects, the UE 120 may be configured to perform one or more operations described herein based at least in part on the configuration information.

The UE 120 may receive, from the network node 110a, a configuration for predicting one or more parameters associated with UE mobility, wherein the configuration indicates a first set of one or more measurement targets or prediction targets including at least one measurement or prediction target associated with communications between the UE 120 and at least one of the network node 110a or network node 110b. For example, the UE 120 may receive configurations to measure and predict beams on multiple frequencies to support stable communication during mobility events. As a result, receiving a configuration for prediction may enhance the UE ability to anticipate and respond to changes in connectivity.

In some aspects, detailed prediction configuration options provide various strategies for spatial prediction, intra-frequency prediction, inter-frequency prediction, and temporal beam or cell prediction. For example, the UE 120 may focus on serving cell beams exclusively or incorporate neighboring cell measurements for more comprehensive predictions. Offering a range of prediction configurations may enable improved network resource utilization.

In some aspects, the one or more measurement targets or prediction targets may include at least one of one or more frequencies, one or more cells, one or more communication beams of a serving cell associated with the network node 110a, one or more communication beams of a neighboring cell associated with the network node 110b having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction. For example, the UE 120 may be configured to monitor specific frequency bands and cell identifiers to determine optimal beam paths. Including multiple types of targets may enable comprehensive prediction modeling for various communication scenarios.

In some aspects, inference configuration for AI/ML based mobility may involve options for using a single measObjectID for both sets or separate measObjectIDs for Set A and Set B, affecting the reporting and prediction process. For example, a shared measObjectID may streamline reporting, while separate IDs may enhance tracking precision for each prediction set. Tailoring inference configurations may improve prediction accuracy.

In some aspects, as shown by reference number 715, the network node 110a may transmit, and the UE 120 may receive, the configuration. For example, the network node 110a may send configurations that detail which beams the UE 120 is to monitor for prediction purposes during handover scenarios. As a result, transmitting the configuration to the UE 120 may help the UE 120 be properly equipped to handle complex mobility patterns.

In some aspects, signaling for life cycle management may include reconfiguration, activation, or deactivation of inference configurations based on monitoring results or UE requests, alongside signaling between serving and neighboring network nodes. For example, a UE request may trigger reconfiguration to activate new prediction settings. Incorporating life cycle management (LCM) signaling may support timely adaptation to evolving mobility needs.

In some aspects, different options for measurement configuration updates for network-side models may involve the network node 110a coordinating updates with candidate/neighbor nodes. For example, a change in CSI-RS beam status may prompt a reconfiguration of measurement targets. Flexible measurement configurations may support dynamic network responses to mobility challenges.

In some aspects, detailed capability exchange and reporting for beam management may involve initial procedures for sending UECapabilityEnquiry and UECapabilityInformation messages, along with reporting Top-1/Top-K predicted CSI-RS beams. For example, the UE 120 may report the strongest anticipated beams for efficient beam management. Accurate capability exchange and reporting may enhance network beam management strategies.

In some aspects, as shown by reference number 720, the network node 110a may communicate, with the network node 110b, the configuration that indicates the first set of one or more measurement targets or prediction targets. For example, the network node 110a may share prediction target information with neighbor nodes to synchronize handover procedures. As a result, communicating the configuration may facilitate seamless transitions between network nodes during UE mobility.

In some aspects, as shown by reference number 725, the UE 120 may predict the one or more parameters associated with the UE mobility. For example, the UE 120 may use measurements of neighboring cells to predict potential coverage gaps during movement. As a result, predicting parameters associated with UE mobility may help to maintain continuous service quality.

In some aspects, as shown by reference number 730, the UE 120 may measure each measurement target of the first set of one or more measurement targets or prediction targets. For example, the UE 120 may scan for signal strengths on specific beams across different frequencies as part of the measurement process. As a result, measuring each target may provide the UE 120 with comprehensive data to support accurate predictions.

In some aspects, as shown by reference number 735, the UE 120 may predict each prediction target of the first set of one or more measurement targets or prediction targets. For example, the UE 120 may predict the quality of future connections by analyzing current signal conditions from surrounding beams. As a result, predicting each target may enable proactive network adjustments to maintain optimal connectivity.

Additionally, or alternatively, the UE 120 may predict, using a beam prediction model, one or more targets of the second set of one or more measurement targets or prediction targets in accordance with receiving the updated configuration. For example, upon receiving new configuration parameters, the UE 120 may adjust its prediction model to focus on different beam targets. Adjusting prediction targets based on updated configurations may improve prediction accuracy.

Additionally, or alternatively, measuring and predicting each target may be associated with transmitting an indication to add one or more measurement targets or prediction targets to the first set of one or more measurement targets or prediction targets in accordance with determining that at least one performance metric associated with the targets fails to satisfy a performance metric threshold. For example, the UE 120 may identify certain beams that require additional monitoring due to fluctuating signal quality. Adding targets based on performance metrics may enhance prediction reliability.

Additionally, or alternatively, measuring and predicting each target may include transmitting an indication to remove one or more measurement targets or prediction targets from the first set of one or more measurement targets or prediction targets in accordance with determining that at least one performance metric associated with the targets fails to satisfy a performance metric threshold. For example, the UE 120 may determine that specific beams are no longer relevant for prediction due to stable signal conditions. Removing targets based on performance metrics may streamline the prediction process.

In some aspects, as shown by reference number 740, the network node 110a may monitor one or more performance metrics associated with the first set of one or more measurement targets or prediction targets. For example, the network node 110a may evaluate metrics like signal strength and interference levels to assess prediction accuracy. As a result, monitoring performance metrics may allow for timely adjustments to prediction algorithms to enhance accuracy.

In some aspects, as shown by reference number 745, the UE 120 may transmit, to the network node 110a, a measurement or prediction report including one or more measurements or predictions corresponding to the first set of one or more measurement targets or prediction targets in accordance with the configuration. For example, the UE 120 may report predicted beam performance during anticipated handover scenarios. As a result, transmitting measurement or prediction reports may provide the network with critical insights for improving connectivity strategies.

In some aspects, as shown by reference number 750, receiving a measurement and inference report may include a performance metric associated with each measurement target and each prediction target of the first set of one or more measurement targets or prediction targets. For example, the UE 120 may provide detailed metrics for each monitored beam to assist the network in evaluating prediction success. Detailed performance metrics may enable precise adjustments to prediction models.

In some aspects, as shown by reference number 750, the life cycle management message may include an indication to add one or more measurement targets or prediction targets to the first set of one or more measurement targets or prediction targets. For example, the message may suggest adding new beam targets based on recent prediction inaccuracies. As a result, including indications to update targets may refine the prediction model for improved future performance.

Additionally, or alternatively, the life cycle management message may include an indication to remove one or more measurement targets or prediction targets from the first set to obtain the second set of one or more measurement targets or prediction targets. For example, the network may instruct the UE 120 to cease monitoring certain beams due to stable signal conditions. Removing targets may improve prediction model efficiency.

Additionally, or alternatively, receiving the life cycle management message including the updated configuration may be in response to transmitting the indication to add the one or more measurement targets or prediction targets. For example, the network may provide new configurations to accommodate additional monitoring needs identified by the UE 120. Providing updates in response to additions may enhance network adaptability.

Additionally, or alternatively, receiving the life cycle management message including the updated configuration may be in response to transmitting the indication to remove the one or more measurement targets or prediction targets. For example, the network may adjust configurations to exclude beams that the UE 120 determined were redundant. Removing redundant targets may streamline network operations.

In some aspects, as shown by reference number 755, the network node 110a may forward, to the network node 110b, the measurement or prediction report including one or more measurements or predictions corresponding to the first set of one or more measurement targets or prediction targets in accordance with the configuration. For example, the network node 110a may share detailed prediction reports with network node 110b to coordinate adjustments in beam configurations. As a result, forwarding reports may strengthen network-wide collaboration to enhance UE mobility support.

In some aspects, as shown by reference number 760, the network node 110a may receive the updated configuration in response to forwarding the measurement or prediction report, wherein transmitting the updated configuration is in accordance with receiving the updated configuration. For example, after sharing prediction results, the network node 110a may obtain new beam configurations from neighboring nodes to address identified performance gaps. As a result, receiving updated configurations may enable adaptive network responses to dynamic mobility challenges.

In some aspects, as shown by reference number 765, the network node 110a may receive an acknowledgement message in response to the updated configuration, wherein transmitting the life cycle management message is in accordance with receiving the acknowledgement message. For example, the network node 110a may receive confirmation that the new beam targets have been successfully integrated into the prediction model. As a result, receiving acknowledgement messages may validate configuration updates and increase consistency in network operations.

In some aspects, as shown by reference number 770, the network node 110a may transmit, to the UE 120, a life cycle management message including an updated configuration that indicates a second set of one or more measurement targets or prediction targets associated with communications between the UE 120 and at least one of the network node 110a or the network node 110b. For example, the node may distribute configurations that encompass new frequencies and cells to be monitored based on recent performance data. As a result, transmitting updated configurations may enhance the UE capability to adapt to evolving network environments.

In some aspects, as shown by reference number 775, the network node 110a may transmit, to the UE 120, a paging message to pause measurement and inference reporting. For example, the network may instruct the UE 120 to halt reporting during overload scenarios to manage network resources effectively. As a result, transmitting a paging message to pause reporting may help prevent unnecessary data transmission and improve network stability.

As indicated above, FIG. 7 is provided as an example. Other examples may differ from what is described with regard to FIG. 7.

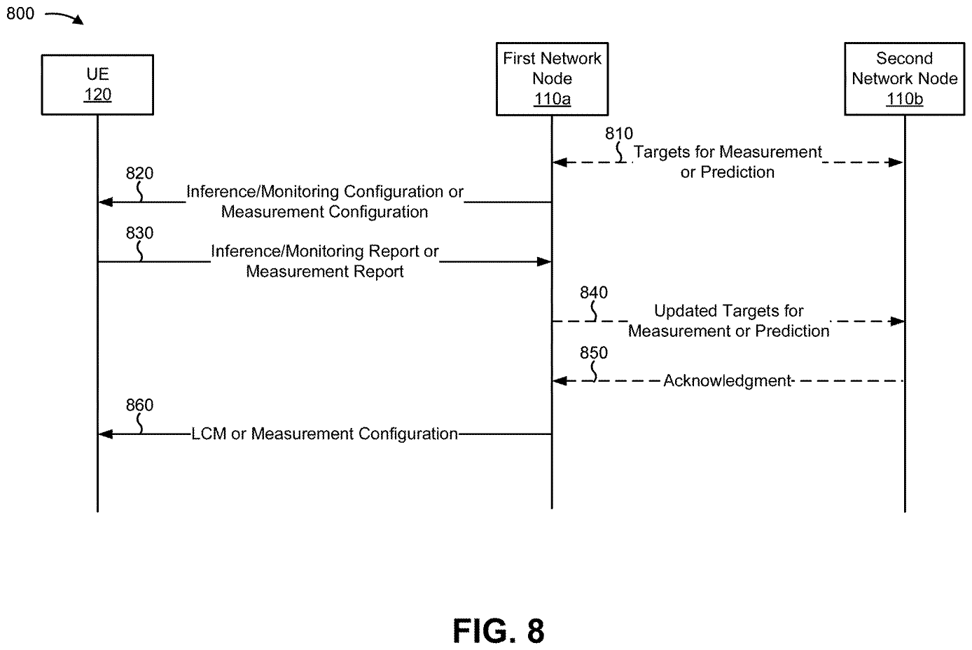

FIG. 8 is a diagram of an example 800 associated with serving network-node-side monitoring or measurement. As shown in FIG. 8, a network node 110a, which may be an example of a serving network node, and a network node 110b, which may be an example of a neighbor or neighboring network node, may communicate with a UE 120. The multiple network nodes 110 may include one or more CUs, one or more DUs, one or more RUs, one or more core network nodes, one or more network servers, one or more application servers, or one or more access and mobility management functions (AMFs), among other examples. In some aspects, the UE 120 and the first network node 110a may be part of a wireless network (e.g., wireless communication network 100). The UE 120 and the first network node 110a may have established a wireless connection prior to operations shown in FIG. 8.

In the example of UE-side inference models, the network node 110a may perform performance monitoring of the inference model. The network node 110a may make LCM decisions and may add or remove one or more frequencies, one or more cells, and/or one or more beams of one or more cells or across cells from the measurement and/or prediction targets, and/or event detection (e.g., for example, for event prediction (e.g., A1-A6 events) according to the added or removed targets).

In the example of network-side inference models, the network node 110a may perform performance monitoring of the inference model based on the information received from the network node 110b.

In some aspects, as shown by reference number 810, the first network node 110a and the second network node 110b may communicate a configuration for predicting one or more parameters associated with UE mobility. In such aspects, the configuration may indicate a first set of one or more measurement targets or prediction targets including at least one measurement or prediction target associated with communications between the UE 120 and at least one of the first network node 110a or the second network node 110b.

For example, the network node 110a may indicate one or more cell or beam targets for which the network node 110a will perform measurement or inference or for which the network node 110a will monitor one or more performance metrics associated with using a predictive model (e.g., an inference model, a machine learning model or an AI model) to infer the one or more cell or beam targets.

In some aspects, the targets may include one or more mobility-triggered events including events in addition to a radio link failure event. For example, the network node 110a may predict A1 through A6 events that indicate various handover and signal quality thresholds. A1 events may include a serving cell signal quality exceeding a threshold, which may void a current handover procedure. A2 events may include a serving cell signal quality falling below the threshold, in some examples, causing a blind handover procedure. A3 events may include a neighbor cell signal quality exceeding a serving cell signal quality when taking into account a frequency offset, which may cause an intra-frequency or an inter-frequency handover procedure. A4 events may include a neighbor cell signal quality exceeding a threshold, triggering a handover procedure to the neighbor cell. A5 events may include a serving cell signal quality falling below the threshold and a neighbor cell signal quality exceeding the threshold, which may cause an intra-frequency or an inter-frequency handover procedure. A6 events may include a signal quality of a neighbor cell exceeding a serving cell signal quality when carrier aggregation is being implemented. By performing prediction for a range of events, the network node 110a may improve the overall accuracy and reliability of network management strategies.

In the example of network-side inference models, the network node 110a may request the neighboring network node 110b to provide cell and beam information (e.g., by providing frequency information). In some aspects, the network node 110b may transmit a list of cells and beam information to the network node 110a (e.g., per frequency) in response to the request.

In some aspects, as shown by reference number 820, for UE-side inference models, the UE 120 may receive, from the network node 110a, the configuration for predicting one or more parameters associated with UE mobility, where the configuration indicates the first set of one or more measurement targets or prediction targets including at least one measurement or prediction target associated with communications between the UE 120 and at least one of the serving network node 110a or a neighbor network node 110b. For example, the network node 110a may select cells or beams for measurements and predictions based on the current network conditions and UE mobility patterns. As a result, the configuration for predicting parameters associated with UE mobility may enhance the accuracy of mobility predictions, leading to improved handover performance and reduced dropped calls.

In some other aspects, as shown by reference number 820, for network-side inference models, the UE 120 may receive, from the network node 110a, a measurement configuration for network-side prediction of one or more parameters associated with UE mobility, where the measurement configuration indicates one or more measurement targets including at least one measurement target associated with communications between the UE 120 and at least one of the serving network node 110a or a neighbor network node 110b.

As shown by reference number 830, for UE-side inference models, the UE 120 may transmit, and the network node 110a may receive, an inference or monitoring report.

In some other aspects, as shown by reference number 830, for network-side inference models, the UE 120 may transmit, and the network node 110a may receive, a measurement report. The network node 110a may compile the measurement configuration based on the UE capability for measurement for the network-side inference model. Based on the measurement results from the UE, described in connection with reference number 830, and prediction results at the network node 110a, the network node 110a may update the measurement configuration by adding or removing one or more frequencies, one or more cells, or one or more beams of one or more cells or across cells from the set of targets.

As shown by reference number 840, the network node 110a may transmit, and the network node 110b may receive, updated targets for measurement or prediction. For example, based on receiving the inference/monitoring report or the measurement report, described in connection with reference number 830, the network node 110a may determine to add or remove one or more targets from the set of one or more targets for measurement or prediction, and may transmit an indication of the updated configuration including the targets to the network node 110b. In some aspects, the network node 110a may indicate one or more frequencies, one or more cells, or one or more beams of one or more cells or across cells that the network node 110a has determined to add or remove from the measurement or prediction target set, and/or has determined to add to event detection, for example, due to poor prediction results (e.g., as obtained from the UE report described in connection with reference number 830).

For network-side inference models, the network node 110a may request the neighboring network node 110b to provide cell and beam information (e.g., by providing frequency information described in connection with reference number 840).

As shown by reference number 850, the network node 110b may transmit, and the network node 110a may receive, an acknowledgement message in response to the updated configuration. In some aspects, the acknowledgement message may include a suggestion to add or remove one or more targets, such as one or more frequencies, one or more cells, and/or one or more beams of one or more cells or across cells.

In the example of network-side inference models, the network node 110b may provide the acknowledgement message, one or more preferences, or one or more suggestions for removing or adding one or more frequencies, one or more cells, and/or one or more beams of one or more cells or across cells from the prediction targets.

As shown by reference number 860, for UE-side inference models, the network node 110a may transmit, and the UE 120 may receive, an LCM configuration. For example, the LCM configuration may reflect the added or removed inference targets from the set of targets.

Based on the monitoring result or UE request, the UE 120 may be updated with one or more measurement objects for measurement or prediction. LCM signaling (e.g., reconfiguration, activation, or deactivation) may be supported for AI/ML-based mobility where the inference configuration may be reconfigured, activated, deactivated. In some aspects, the LCM message may indicate a cause of requesting activation/deactivation, such as a size or contents of measurement objects for measurement and prediction targets/events. For example, when the prediction targets are sufficiently smaller than measurement targets, the UE 120 may choose to reject or request deactivation of the inference model.

As shown by reference number 860, for network-side inference models, the network node 110a may transmit, and the UE 120 may receive, a measurement configuration. For example, the measurement configuration may reflect the added or removed measurement targets from the set of targets.

FIG. 8 is provided as an example. Other examples may differ from what is described with regard to FIG. 8.

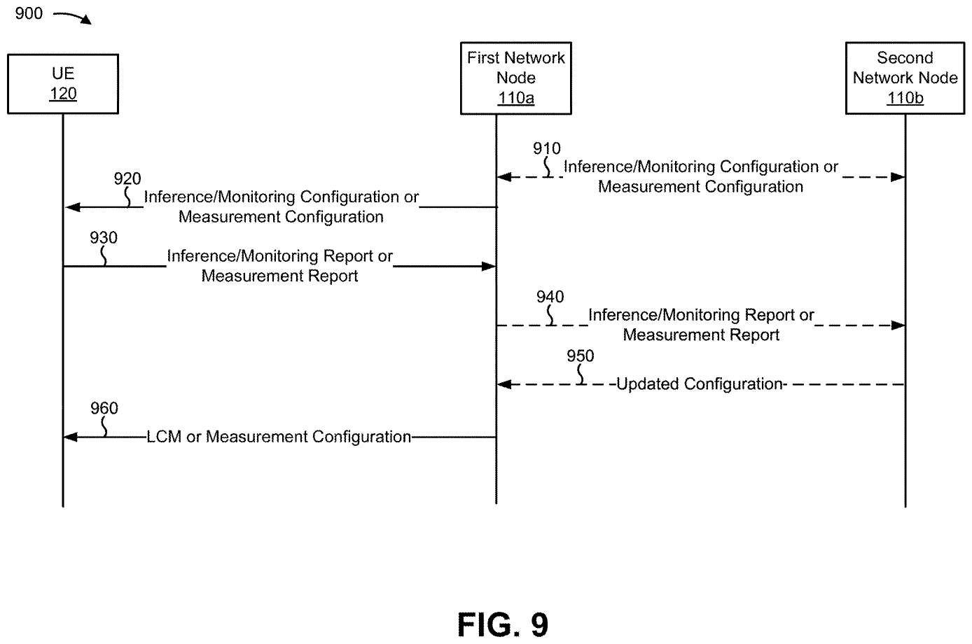

FIG. 9 is a diagram of an example 900 associated with neighbor network-node-side monitoring or measurement. As shown in FIG. 9, a network node 110a, which may be an example of a serving network node, and a network node 110b, which may be an example of a neighbor or neighboring network node, may communicate with a UE 120. The multiple network nodes 110 may include one or more CUs, one or more DUs, one or more RUs, one or more core network nodes, one or more network servers, one or more application servers, or one or more AMFs, among other examples. In some aspects, the UE 120 and the first network node 110a may be part of a wireless network (e.g., wireless communication network 100). The UE 120 and the first network node 110a may have established a wireless connection prior to operations shown in FIG. 9.

In the example of UE-side inference models, the network node 110b may perform performance monitoring of the inference model. The network node 110b may make LCM decisions and may add or remove one or more frequencies, one or more cells, and/or one or more beams of one or more cells or across cells from the measurement and/or prediction targets, and/or from event detection (e.g., for example, for event prediction (e.g., A1-A6 events) according to the added or removed targets).

In the example of network-side inference models, the network node 110b may perform performance monitoring of the inference model based on the information received from the network node 110a or the UE 120.

In some aspects, as shown by reference number 910, for UE-side inference models, the network node 110b and the network node 110a may communicate a configuration for predicting one or more parameters associated with UE mobility, where the configuration indicates the first set of one or more measurement targets or prediction targets including at least one measurement or prediction target associated with communications between the UE 120 and at least one of the serving network node 110a or the neighbor network node 110b. For example, the network node 110b may select cells or beams for measurements and predictions based on the current network conditions and UE mobility patterns. As a result, the configuration for predicting parameters associated with UE mobility may enhance the accuracy of mobility predictions, leading to improved handover performance and reduced dropped calls.

In some other aspects, as shown by reference number 910, for network-side inference models, the network node 110b and the network node 110a may communicate a measurement configuration for network-side prediction of one or more parameters associated with UE mobility, where the measurement configuration indicates one or more measurement targets including at least one measurement target associated with communications between the UE 120 and at least one of the serving network node 110a or the neighbor network node 110b.

As shown by reference number 920, for UE-side inference models, the UE 120 may receive, from the network node 110a, the configuration for predicting one or more parameters associated with UE mobility, where the configuration indicates the first set of one or more measurement targets or prediction targets including at least one measurement or prediction target associated with communications between the UE 120 and at least one of the serving network node 110a or the neighbor network node 110b.

In some other aspects, as shown by reference number 920, for network-side inference models, the UE 120 may receive, from the network node 110a, a measurement configuration for network-side prediction of one or more parameters associated with UE mobility, where the measurement configuration indicates one or more measurement targets including at least one measurement target associated with communications between the UE 120 and at least one of the serving network node 110a or the neighbor network node 110b.

As shown by reference number 930, for UE-side inference models, the UE 120 may transmit, and the network node 110a may receive an inference or monitoring report.

In some other aspects, as shown by reference number 930, for network-side inference models, the UE 120 may transmit, and the network node 110a may receive, a measurement report.

As shown by reference number 940, for UE-side inference models, the network node 110a may forward the inference or monitoring report to the network node 110b. In some aspects, the network node 110b may perform monitoring of the inference model. In some aspects, the network node 110b may make LCM decisions to add or remove one or more frequencies, one or more cells, and/or one or more beams of one or more cells or across cells from the set of measurement, and/or prediction targets, and/or from event prediction (e.g., A1-A6 events). As a result, communication between network nodes for predicting UE mobility parameters may lead to more cohesive network operations and better management of network resources.

In the context of inference models at another network node, the network node 110b may perform or update the measurement configuration based on factors like network energy saving considerations, CSI-RS beam status changes (e.g., from periodic to semi-periodic, among other examples), or inference monitoring (e.g., when shared by the network node 110a with the network node 110b). The network node 110b may suggest/provide one or more frequencies, one or more cells, or one or more beams of one or more cells or across cells to add or remove from the measurement targets.

In the context of inference models at the network node 110b, the network node 110b may transmit measurement configurations (e.g., indicating one or more frequencies, one or more cells, or one or more beams of one or more cells or across cells to add or remove from the set of measurement targets, or from the reporting configuration) for its own model to the network node 110a. The network node 110a may compile the requests (e.g., to add or remove targets) from multiple network nodes (e.g., in accordance with a UE capability for measuring targets associated with multiple neighbor nodes), and may transmit the updated measurement configuration to the UE (e.g., directly or forwarded via the network node 110a). The network node 110a may indicate to the network node 110b one or more frequencies, one or more cells, and/or one or more beams of one or more cells or across cells that have been configured to the UE for measurements based on the request.

As shown by reference number 950, the network node 110b may transmit a message indicating the updated configuration (e.g., including or excluding the added or removed targets).

In the example of UE-side inference models, the updated configuration may include an updated inference configuration. In the example of network-side inference models, the updated configuration may include an updated measurement configuration.

As shown by reference number 960, for UE-side inference models, the network node 110a may transmit, and the UE 120 may receive, an LCM configuration. For example, the LCM configuration may reflect the added or removed inference targets from the set of targets.

Based on the monitoring result or UE request, the UE 120 may be updated with one or more measurement objects for measurement or prediction. LCM signaling (e.g., reconfiguration, activation, or deactivation) may be supported for AI/ML-based mobility where the inference configuration can be reconfigured, activated, or deactivated. In some aspects, the LCM message may indicate a cause of requesting activation/deactivation, such as a size or contents of measurement objects for measurement and prediction targets/events. For example, when the prediction targets are sufficiently smaller than measurement targets, the UE 120 may choose to reject or request deactivation of the inference model.

As shown by reference number 960, for network-side inference models, the network node 110a may transmit, and the UE 120 may receive, the updated measurement configuration. For example, the updated measurement configuration may reflect the added or removed measurement targets from the set of targets.

As indicated above, FIG. 9 is provided as an example. Other examples may differ from what is described with respect to FIG. 9.

In some aspects, features described with respect to FIG. 8 may be combined with features described with respect to FIG. 9. For example, in the context of UE-side inference models, the network node 110a and the network node 110b may jointly perform the LCM decision to add or remove one or more frequencies, one or more cells, and/or one or more beams of one or more cells or across cells from measurement and/or prediction target, and/or from event (e.g., A1-A6 events). In another example, in the context of network-side inference models, the network node 110a and the network node 110b may jointly determine one or more frequencies, one or more cells, and/or one or more beams of one or more cells or across cells to add or remove from the set of measurement targets.

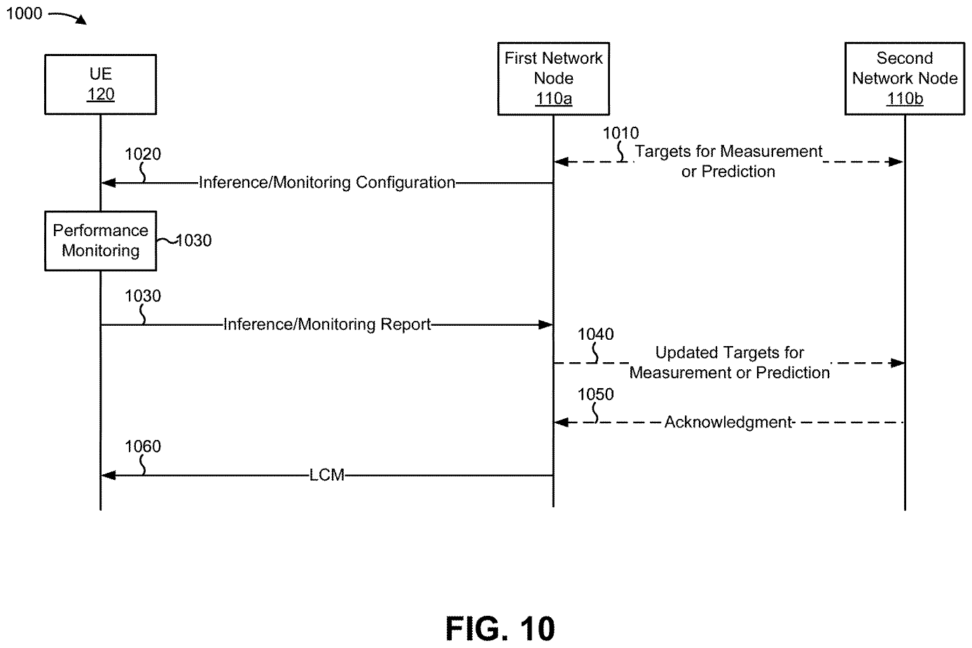

FIG. 10 is a diagram of an example 1000 associated with UE-side monitoring or measurement. As shown in FIG. 10, a network node 110a, which may be an example of a serving network node, and a network node 110b, which may be an example of a neighbor or neighboring network node, may communicate with a UE 120. The multiple network nodes 110 may include one or more CUs, one or more DUs, one or more RUs, one or more core network nodes, one or more network servers, one or more application servers, or one or more AMFs, among other examples. In some aspects, the UE 120 and the first network node 110a may be part of a wireless network (e.g., wireless communication network 100). The UE 120 and the first network node 110a may have established a wireless connection prior to operations shown in FIG. 10.

As shown by reference number 1010, the first network node 110a and the second network node 110b may communicate a configuration for predicting one or more parameters associated with UE mobility. In such aspects, the configuration may indicate a first set of one or more measurement targets or prediction targets including at least one measurement or prediction target associated with communications between the UE 120 and at least one of the first network node 110a or the second network node 110b.

In some aspects, as shown by reference number 1020, for UE-side inference models, the UE 120 may receive, from the network node 110a, the configuration for predicting one or more parameters associated with UE mobility, where the configuration indicates the first set of one or more measurement targets or prediction targets including at least one measurement or prediction target associated with communications between the UE 120 and at least one of the serving network node 110a or the neighbor network node 110b. For example, the network node 110a may select cells or beams for measurements and predictions based on the current network conditions and UE mobility patterns. As a result, the configuration for predicting parameters associated with UE mobility may enhance the accuracy of mobility predictions, leading to improved handover performance and reduced dropped calls.

As shown by reference number 1030, the UE 120 may perform the performance monitoring of the inference model, or may assist in the performance monitoring of the inference model. For example, the UE 120 may determine that the performance for one or more frequencies (e.g., absolute radio frequency channel number (ARFCN), band, band combination), cells, or beams of the cells fall below a performance threshold.

As shown by reference number 1030, the UE may transmit, and the network node 110a may receive, an inference or monitoring report. For example, the UE 120 may send the following to be updated, added, or removed from the targets (e.g., for measurement and/or prediction): one or more frequencies (e.g., ARFCN, band, band combination), one or more cells, one or beams of one or more cells, or from one or more events (e.g., for event prediction (e.g., A1-A6 events)).

As shown by reference number 1040, the network node 110a may transmit the updated targets for measurement or prediction to the network node 110b. For example, upon reception of the monitoring report (e.g., containing an add/remove request) or a UAI message (e.g., containing an add/remove request), the network node 110a may forward the monitoring report/UAI to the network node 110b.

The network node 110b may add or remove one or more frequencies, one or more cells, and/or one or more beams of one or more cells from the measurement or prediction targets, and/or events.

As shown by reference number 1050, the network node 110b may transmit, and the network node 110a may receive, an acknowledgement message including the updated configuration. In some aspects, the acknowledgement message may include a request or command to add or remove one or more targets, such as one or more frequencies, one or more cells, and/or one or more beams of one or more cells or across cells.

As shown by reference number 1060, for UE-side inference models, the network node 110a may transmit, and the UE 120 may receive, an LCM configuration. For example, the LCM configuration may reflect the added or removed inference targets from the set of targets.

Based on the monitoring result or UE request, the UE 120 may be updated with one or more measurement objects for measurement or prediction. LCM signaling (e.g., reconfiguration, activation, or deactivation) may be supported for AI/ML-based mobility where the inference configuration may be reconfigured, activated, or deactivated. In some aspects, the LCM message may indicate a cause of requesting activation/deactivation, such as a size or contents of measurement objects for measurement and prediction targets/events. For example, when the prediction targets are sufficiently smaller than measurement targets, the UE 120 may choose to reject or request deactivation of the inference model.

As indicated above, FIG. 10 is provided as an example. Other examples may differ from what is described with respect to FIG. 10.

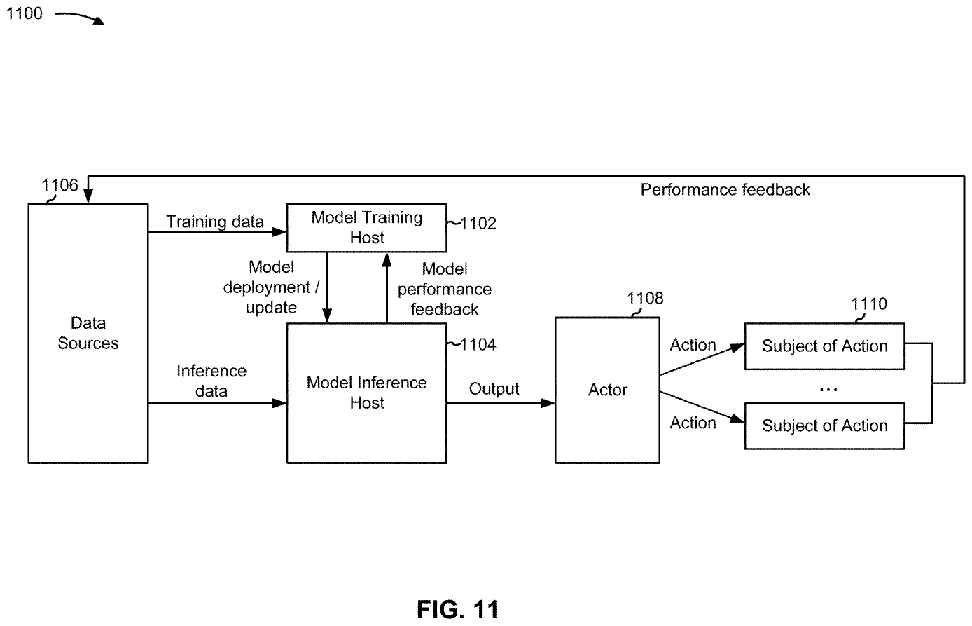

FIG. 11 is a diagram illustrating an example architecture 1100 of a functional framework for radio access network (RAN) intelligence enabled by data collection. In some scenarios, the functional framework for RAN intelligence may be enabled by further enhancement of data collection through use cases or examples. For example, principles or algorithms for RAN intelligence enabled by AI/ML and the associated functional framework (e.g., the AI functionality or the input/output of the component for AI enabled optimization) have been utilized or studied to identify the benefits of AI enabled RAN through possible use cases (e.g., beam management, energy saving, load balancing, mobility management, or coverage optimization, among other examples). In one example, as shown by the architecture 1100, a functional framework for RAN intelligence may include multiple logical entities, such as a model training host 1102, a model inference host 1104, data sources 1106, and an actor 1108.

The model inference host 1104 may be configured to run an AI/ML model based on inference data provided by the data sources 1106, and the model inference host 1104 may produce an output (e.g., a prediction) with the inference data input to the actor 1108. The actor 1108 may be an element or an entity of a core network or a RAN. For example, the actor 1108 may be a UE, a network node, base station (e.g., a gNB), a CU, a DU, or an RU, among other examples. In addition, the actor 1108 may also depend on the type of tasks performed by the model inference host 1104, type of inference data provided to the model inference host 1104, or type of output produced by the model inference host 1104. For example, when the output from the model inference host 1104 is associated with beam management, then the actor 1108 may be a UE, a DU or an RU. In other examples, when the output from the model inference host 1104 is associated with Tx/Rx scheduling, then the actor 1108 may be a CU or a DU.

After the actor 1108 receives an output from the model inference host 1104, the actor 1108 may determine whether to act based on the output. For example, when the actor 1108 is a DU or an RU and the output from the model inference host 1104 is associated with beam management, the actor 1108 may determine whether to change/modify a Tx/Rx beam based on the output. When the actor 1108 determines to act based on the output, the actor 1108 may indicate the action to at least one subject of action 1110. For example, when the actor 1108 determines to change/modify a Tx/Rx beam for a communication between the actor 1108 and the subject of action 1110 (e.g., a UE 120), then the actor 1108 may transmit a beam (re-)configuration or a beam switching indication to the subject of action 1110. The actor 1108 may modify its Tx/Rx beam based on the beam (re-)configuration, such as switching to a new Tx/Rx beam or applying different parameters for a Tx/Rx beam, among other examples. As another example, the actor 1108 may be a UE and the output from the model inference host 1104 may be associated with beam management. For example, the output may be one or more predicted measurement values for one or more beams. The actor 1108 (e.g., a UE) may determine that a measurement report (e.g., a Layer 1 (L1) RSRP report) is to be transmitted to a network node 110.

The data sources 1106 may also be configured for collecting data that is used as training data for training an ML model or as inference data for feeding an ML model inference operation. For example, the data sources 1106 may collect data from one or more core network or RAN entities, which may include the subject of action 1110, and provide the collected data to the model training host 1102 for ML model training. For example, after a subject of action 1110 (e.g., a UE 120) receives a beam configuration from the actor 1108, the subject of action 1110 may provide performance feedback associated with the beam configuration to the data sources 1106, where the performance feedback may be used by the model training host 1102 for monitoring or evaluating the ML model performance, such as whether the output (e.g., prediction) provided to the actor 1108 is accurate. In some examples, when the output provided by the actor 1108 is inaccurate (or the accuracy is below an accuracy threshold), then the model training host 1102 may determine to modify or retrain the ML model used by the model inference host, such as via an ML model deployment/update.

The actor 1108 and a network node 110 may perform activation or deactivation in inference or performance metric monitoring. For example, the applicable AI/ML functionalities may be activated by receiving an inference configuration, as described in connection with FIG. 6.

In the context of beam management, a CSI report configuration (e.g., CSI-ReportConfig) may be activated or deactivated (e.g., using L1/L2/L3 signaling) according to the applicability of the configuration or performance of inference operations. When the applicable AI/ML functionalities are activated, the actor 1108 may be configured to report prediction of all configured cells and beams, and thus there may be some instances where the UE predicts a large quantity of beams, but because the reporting is performed by RRC, the large report may not cause issues related to overhead. However, the network mode may verify whether predictions for the top K beams or the top beam are accurate. When the predictions are not accurate, the network may activate or deactivate the inference model. For example, when UE is configured to predict measurements of cells C:{C₁, C₂, . . . , C_{N}}, and the network node 110 determines that performance of cells C′={C_{K}, C_{K+1}, . . . , C_{L}} falls below a signal quality threshold, then there may not be need for deactivating the inference configuration, but rather the actor 1108 may be configured to not provide predictions for C′={C_{K}, C_{K+1}, . . . , C_{L}} and instead may provide the measurements obtained for the other cells using the model inference host 1104.

As indicated above, FIG. 11 is provided as an example. Other examples may differ from what is described with regard to FIG. 11.

FIG. 12 is a diagram illustrating an example process 1200 performed, for example, at a UE or an apparatus of a UE. Example process 1200 is an example where the apparatus or the UE (e.g., UE 120) performs operations associated with life cycle management signaling for artificial intelligence or machine learning based mobility.

As shown in FIG. 12, in some aspects, process 1200 may include receiving, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node (block 1210). For example, the UE (e.g., using reception component 1502 or communication manager 1506, depicted in FIG. 15) may receive, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node, as described above.

As further shown in FIG. 12, in some aspects, process 1200 may include transmitting, to the serving network node, a measurement or prediction report including one or more measurements or predictions corresponding to the first set of one or more measurement targets or prediction targets in accordance with the configuration (block 1220). For example, the UE (e.g., using transmission component 1504 or communication manager 1506, depicted in FIG. 15) may transmit, to the serving network node, a measurement or prediction report including one or more measurements or predictions corresponding to the first set of one or more measurement targets or prediction targets in accordance with the configuration, as described above.

As further shown in FIG. 12, in some aspects, process 1200 may include receiving, from the serving network node, a life cycle management message including an updated configuration that indicates a second set of one or more measurement targets or prediction targets associated with communications between the UE and at least one of the serving network node or the neighbor network node (block 1230). For example, the UE (e.g., using reception component 1502 or communication manager 1506, depicted in FIG. 15) may receive, from the serving network node, a life cycle management message including an updated configuration that indicates a second set of one or more measurement targets or prediction targets associated with communications between the UE and at least one of the serving network node or the neighbor network node, as described above.

Process 1200 may include additional aspects, such as any single aspect or any combination of aspects described below or in connection with one or more other processes described elsewhere herein.

In a first aspect, process 1200 includes predicting the one or more parameters associated with the UE mobility, wherein the one or more parameters includes at least one of a fixed quantity of highest-ranked cells according to cell quality, a fixed quantity of highest-ranked beams of a serving cell associated with the serving network node, a fixed quantity of highest-ranked beams per configured cell on a frequency of the serving cell, a fixed quantity of highest-ranked beams across a configured cell on the frequency of the serving cell, a fixed quantity of highest-ranked beams per configured cell on one or more frequencies other than the frequency of the serving cell, a fixed quantity of highest-ranked beams across a configured cell on the one or more frequencies other than the frequency of the serving cell, a quality associated with each of the serving cell and one or more neighbor cells, a radio measurement of beams of the serving cell, a radio measurement of beams of one or more neighboring cells on a same frequency, a radio measurement of beams of neighboring cells on frequencies other than serving cell frequency a measurement event associated with at least one of the serving cell or one or more beams associated with the serving cell, a measurement event associated with the serving cell and one or more secondary cells associated with the serving cell, a measurement event associated with at least one of the serving cell of the serving network node, or one or more beams of the serving cell, and at least one of the neighbor cell of the neighbor network node, or one or more beams of the neighbor cell, a radio link failure event at the UE, or a handover failure event at the UE.

In a second aspect, alone or in combination with the first aspect, process 1200 includes measuring each measurement target of the first set of one or more measurement targets or prediction targets, predicting each prediction target of the first set of one or more measurement targets or prediction targets, and transmitting a measurement and inference report including one or more respective performance metric associated with each measurement target or each prediction target of the first set of one or more measurement targets or prediction targets.

In a third aspect, alone or in combination with one or more of the first and second aspects, the life cycle management message includes an indication to add one or more measurement targets or prediction targets to the first set of one or more measurement targets or prediction targets.

In a fourth aspect, alone or in combination with one or more of the first through third aspects, the life cycle management message includes an indication to remove one or more measurement targets or prediction targets from the first set of one or more measurement targets or prediction targets to obtain the second set of one or more measurement targets or prediction targets.

In a fifth aspect, alone or in combination with one or more of the first through fourth aspects, process 1200 includes measuring each measurement target of the first set of one or more measurement targets or prediction targets, predicting each prediction target of the first set of one or more measurement targets or prediction targets, and transmitting, to the serving network node, an indication to add one or more measurement targets or prediction targets to the first set of one or more measurement targets or prediction targets in accordance with determining that at least one performance metric associated with the one or more measurement targets or prediction targets fails to satisfy a performance metric threshold.

In a sixth aspect, alone or in combination with one or more of the first through fifth aspects, receiving the life cycle management message including the updated configuration is in response to transmitting the indication to add the one or more measurement targets or prediction targets.

In a seventh aspect, alone or in combination with one or more of the first through sixth aspects, process 1200 includes measuring each measurement target of the first set of one or more measurement targets or prediction targets, predicting each prediction target of the first set of one or more measurement targets or prediction targets, and transmitting, to the serving network node, an indication to remove one or more measurement targets or prediction targets from the first set of one or more measurement targets or prediction targets in accordance with determining that at least one performance metric associated with the one or more measurement targets or prediction targets fails to satisfy a performance metric threshold.

In an eighth aspect, alone or in combination with one or more of the first through seventh aspects, receiving the life cycle management message including the updated configuration is in response to transmitting the indication to remove the one or more measurement targets or prediction targets.

In a ninth aspect, alone or in combination with one or more of the first through eighth aspects, process 1200 includes transmitting, to the serving network node, a capability information message indicating one or more supported prediction or measurement functionalities, wherein the updated configuration indicates the second set of one or more measurement targets or prediction targets in accordance with the one or more supported prediction or measurement functionalities.

In a tenth aspect, alone or in combination with one or more of the first through ninth aspects, process 1200 includes predicting, using a beam prediction model in accordance with receiving the updated configuration, one or more targets of the second set of one or more measurement targets or prediction targets.

In an eleventh aspect, alone or in combination with one or more of the first through tenth aspects, process 1200 includes receiving, from the serving network node, a paging message to pause measurement and inference reporting.

In a twelfth aspect, alone or in combination with one or more of the first through eleventh aspects, the second set of one or more measurement targets or prediction targets is a modified set of prediction targets according to previous prediction performance metrics.

In a thirteenth aspect, alone or in combination with one or more of the first through twelfth aspects, the one or more measurement targets or prediction targets include at least one of one or more frequencies, one or more cells, one or more communication beams of a serving cell associated with the serving network node, one or more communication beams, of a neighboring cell associated with the neighbor network node, having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a serving network node or an apparatus of a serving network node. Example process 1300 is an example where the apparatus or the serving network node (e.g., serving network node 110) performs operations associated with life cycle management signaling for artificial intelligence or machine learning based mobility.

As shown in FIG. 13, in some aspects, process 1300 may include transmitting, to a UE, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node (block 1310). For example, the serving network node (e.g., using transmission component 1604 or communication manager 1606, depicted in FIG. 16) may transmit, to a UE, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node, as described above.

As further shown in FIG. 13, in some aspects, process 1300 may include receiving, from the UE, a measurement or prediction report including one or more measurements or predictions corresponding to the first set of one or more measurement targets or prediction targets in accordance with the configuration (block 1320). For example, the serving network node (e.g., using reception component 1602 or communication manager 1606, depicted in FIG. 16) may receive, from the UE, a measurement or prediction report including one or more measurements or predictions corresponding to the first set of one or more measurement targets or prediction targets in accordance with the configuration, as described above.

As further shown in FIG. 13, in some aspects, process 1300 may include transmitting, to the UE, a life cycle management message including an updated configuration that indicates a second set of one or more measurement targets or prediction targets associated with communications between the UE and at least one of the serving network node or the neighbor network node (block 1330). For example, the serving network node (e.g., using transmission component 1604 or communication manager 1606, depicted in FIG. 16) may transmit, to the UE, a life cycle management message including an updated configuration that indicates a second set of one or more measurement targets or prediction targets associated with communications between the UE and at least one of the serving network node or the neighbor network node, as described above.

Process 1300 may include additional aspects, such as any single aspect or any combination of aspects described below or in connection with one or more other processes described elsewhere herein.

In a first aspect, process 1300 includes receiving a measurement and inference report including a performance metric associated with each measurement target and each prediction target of the first set of one or more measurement targets or prediction targets.

In a second aspect, alone or in combination with the first aspect, the life cycle management message includes an indication to add one or more measurement targets or prediction targets to the first set of one or more measurement targets or prediction targets.

In a third aspect, alone or in combination with one or more of the first and second aspects, the life cycle management message includes an indication to remove one or more measurement targets or prediction targets from the first set of one or more measurement targets or prediction targets to obtain the second set of one or more measurement targets or prediction targets.

In a fourth aspect, alone or in combination with one or more of the first through third aspects, process 1300 includes receiving, from the UE, an indication to add one or more measurement targets or prediction targets to the first set of one or more measurement targets or prediction targets in accordance with determining that at least one performance metric associated with the one or more measurement targets or prediction targets fails to satisfy a performance metric threshold.

In a fifth aspect, alone or in combination with one or more of the first through fourth aspects, transmitting the life cycle management message including the updated configuration is in response to transmitting the indication to add the one or more measurement targets or prediction targets.

In a sixth aspect, alone or in combination with one or more of the first through fifth aspects, process 1300 includes receiving, from the UE, an indication to remove one or more measurement targets or prediction targets from the first set of one or more measurement targets or prediction targets in accordance with determining that at least one performance metric associated with the one or more measurement targets or prediction targets fails to satisfy a performance metric threshold.

In a seventh aspect, alone or in combination with one or more of the first through sixth aspects, transmitting the life cycle management message including the updated configuration is in response to transmitting the indication to remove the one or more measurement targets or prediction targets.

In an eighth aspect, alone or in combination with one or more of the first through seventh aspects, process 1300 includes receiving, from the UE, a capability information message indicating one or more supported prediction or measurement functionalities, wherein the updated configuration indicates the second set of one or more measurement targets or prediction targets in accordance with the one or more supported prediction or measurement functionalities.

In a ninth aspect, alone or in combination with one or more of the first through eighth aspects, process 1300 includes transmitting, to the UE, a paging message to pause measurement and inference reporting.

In a tenth aspect, alone or in combination with one or more of the first through ninth aspects, the second set of one or more measurement targets or prediction targets is a modified set of prediction targets according to one or more past prediction performance metrics.

In an eleventh aspect, alone or in combination with one or more of the first through tenth aspects, the updated configuration indicates that the UE is to perform beam inference reporting for a subset of all predicted beams.

In a twelfth aspect, alone or in combination with one or more of the first through eleventh aspects, the updated configuration indicates one or more inter-frequency prediction targets.

In a thirteenth aspect, alone or in combination with one or more of the first through twelfth aspects, process 1300 includes transmitting, to the UE, a request to provide a measurement and inference report for all configured cells and beams.

In a fourteenth aspect, alone or in combination with one or more of the first through thirteenth aspects, the one or more measurement targets or prediction targets include at least one of one or more frequencies, one or more cells, one or more communication beams of a serving cell associated with the serving network node, one or more communication beams, of a neighboring cell associated with the neighbor network node, having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction.

In a fifteenth aspect, alone or in combination with one or more of the first through fourteenth aspects, process 1300 includes communicating, with the neighbor network node, the configuration that indicates the first set of one or more measurement targets or prediction targets.

In a sixteenth aspect, alone or in combination with one or more of the first through fifteenth aspects, process 1300 includes monitoring one or more performance metrics associated with the first set of one or more measurement targets or prediction targets.

In a seventeenth aspect, alone or in combination with one or more of the first through sixteenth aspects, process 1300 includes transmitting, to the neighbor network node, an indication of the updated configuration, and receiving an acknowledgement message in response to the updated configuration, wherein transmitting the life cycle management message is in accordance with receiving the acknowledgement message.

In an eighteenth aspect, alone or in combination with one or more of the first through seventeenth aspects, the acknowledgement message includes an indication to add or remove one or more measurement targets or prediction targets from the updated configuration.

In a nineteenth aspect, alone or in combination with one or more of the first through eighteenth aspects, process 1300 includes forwarding, to the neighbor network node, the measurement or prediction report including one or more measurements or predictions corresponding to the first set of one or more measurement targets or prediction targets in accordance with the configuration, and receiving the updated configuration in response to forwarding the measurement or prediction report, wherein transmitting the updated configuration is in accordance with receiving the updated configuration.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram illustrating an example process 1400 performed, for example, at a first network node or an apparatus of a first network node. Example process 1400 is an example where the apparatus or the first network node (e.g., first network node 110) performs operations associated with life cycle management signaling for artificial intelligence or machine learning based mobility.

As shown in FIG. 14, in some aspects, process 1400 may include communicating, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node (block 1410). For example, the first network node (e.g., using reception component 1602, transmission component 1604, or communication manager 1606, depicted in FIG. 16) may communicate, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node, as described above.

As further shown in FIG. 14, in some aspects, process 1400 may include transmitting, to the second network node, an updated configuration that indicates a second set of one or more measurement targets or prediction targets associated with communications between the UE and at least one of the first network node or the second network node (block 1420). For example, the first network node (e.g., using transmission component 1604 or communication manager 1606, depicted in FIG. 16) may transmit, to the second network node, an updated configuration that indicates a second set of one or more measurement targets or prediction targets associated with communications between the UE and at least one of the first network node or the second network node, as described above.

Process 1400 may include additional aspects, such as any single aspect or any combination of aspects described below or in connection with one or more other processes described elsewhere herein.

In a first aspect, process 1400 includes predicting the one or more parameters associated with the UE mobility, wherein the one or more parameters includes at least one of a fixed quantity of highest-ranked cells according to cell quality, a fixed quantity of highest-ranked beams of a serving cell associated with a serving network node, a fixed quantity of highest-ranked beams per configured cell on a frequency of the serving cell, a fixed quantity of highest-ranked beams across a configured cell on the frequency of the serving cell, a fixed quantity of highest-ranked beams per configured cell on one or more frequencies other than the frequency of the serving cell, a fixed quantity of highest-ranked beams across a configured cell on the one or more frequencies other than the frequency of the serving cell, a quality associated with each of the serving cell and one or more neighbor cells, a radio measurement of beams of the serving cell, a radio measurement of beams of one or more neighboring cells on a same frequency, a radio measurement of beams of neighboring cells on frequencies other than serving cell frequency a measurement event associated with at least one of the serving cell or one or more beams associated with the serving cell, a measurement event associated with the serving cell and one or more secondary cells associated with the serving cell, a measurement event associated with at least one of the serving cell of the serving network node, or one or more beams of the serving cell, and at least one of the neighbor cell of a neighbor network node, or one or more beams of the neighbor cell, a radio link failure event at the UE, or a handover failure event at the UE.

In a second aspect, alone or in combination with the first aspect, process 1400 includes receiving, from the second network node, an acknowledgement message in response to the updated configuration, and transmitting, to the UE, an indication of the updated configuration in accordance with receiving the acknowledgement message.

In a third aspect, alone or in combination with one or more of the first and second aspects, the acknowledgement message includes an indication to add or remove one or more measurement targets or prediction targets from the updated configuration.

In a fourth aspect, alone or in combination with one or more of the first through third aspects, the configuration includes a request for the second network node to provide performance metrics associated with the first set of one or more measurement targets or prediction targets.

In a fifth aspect, alone or in combination with one or more of the first through fourth aspects, the first network node is a serving network node, and the second network node is a neighbor network node.

In a sixth aspect, alone or in combination with one or more of the first through fifth aspects, the first network node is a neighbor network node, and the second network node is a serving network node.

In a seventh aspect, alone or in combination with one or more of the first through sixth aspects, process 1400 includes removing or adding, by the first network node, one or more measurement targets or prediction targets from the first set of one or more measurement targets or prediction targets to obtain the second set of one or more measurement targets or prediction targets.

In an eighth aspect, alone or in combination with one or more of the first through seventh aspects, process 1400 includes receiving, from a UE, a measurement or prediction report including one or more measurements or predictions corresponding to the first set of one or more measurement targets or prediction targets in accordance with the configuration.

In a ninth aspect, alone or in combination with one or more of the first through eighth aspects, the one or more measurement targets or prediction targets include at least one of one or more frequencies, one or more cells, one or more communication beams of a serving cell associated with a serving network node, one or more communication beams, of a neighboring cell associated with a neighbor network node, having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction.

Although FIG. 14 shows example blocks of process 1400, in some aspects, process 1400 may include additional blocks, fewer blocks, different blocks, or differently arranged blocks than those depicted in FIG. 14. Additionally, or alternatively, two or more of the blocks of process 1400 may be performed in parallel.

FIG. 15 is a diagram of an example apparatus 1500 for wireless communication. The apparatus 1500 may be a UE, or a UE may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 150 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 140 described in connection with FIG. 1) of the UE.

In some aspects, the apparatus 1500 may be configured to perform one or more operations described herein in connection with FIGS. 7-11. Additionally, or alternatively, the apparatus 1500 may be configured to perform one or more processes described herein, such as process 1200 of FIG. 12, or a combination thereof. In some aspects, the apparatus 1500 or one or more components shown in FIG. 15 may include one or more components of the UE described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the UE described above in connection with FIG. 1, such as a radio, one or more RF chains, one or more transceivers, or one or more modems, each of which may in turn be coupled with one or more antennas of the UE.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The reception component 1502 may receive, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The transmission component 1504 may transmit, to the serving network node, a measurement or prediction report including one or more measurements or predictions corresponding to the first set of one or more measurement targets or prediction targets in accordance with the configuration. The reception component 1502 may receive, from the serving network node, a life cycle management message including an updated configuration that indicates a second set of one or more measurement targets or prediction targets associated with communications between the UE and at least one of the serving network node or the neighbor network node.

The communication manager 1506 may predict the one or more parameters associated with the UE mobility, wherein the one or more parameters includes at least one of a fixed quantity of highest-ranked cells according to cell quality, a fixed quantity of highest-ranked beams of a serving cell associated with the serving network node, a fixed quantity of highest-ranked beams per configured cell on a frequency of the serving cell, a fixed quantity of highest-ranked beams across a configured cell on the frequency of the serving cell, a fixed quantity of highest-ranked beams per configured cell on one or more frequencies other than the frequency of the serving cell, a fixed quantity of highest-ranked beams across a configured cell on the one or more frequencies other than the frequency of the serving cell, a quality associated with each of the serving cell and one or more neighbor cells, a radio measurement of beams of the serving cell, a radio measurement of beams of one or more neighboring cells on a same frequency, a radio measurement of beams of neighboring cells on frequencies other than serving cell frequency a measurement event associated with at least one of the serving cell or one or more beams associated with the serving cell, a measurement event associated with the serving cell and one or more secondary cells associated with the serving cell, a measurement event associated with at least one of the serving cell of the serving network node, or one or more beams of the serving cell, and at least one of the neighbor cell of the neighbor network node, or one or more beams of the neighbor cell, a radio link failure event at the UE, or a handover failure event at the UE.

The communication manager 1506 may measure each measurement target of the first set of one or more measurement targets or prediction targets.

The communication manager 1506 may predict each prediction target of the first set of one or more measurement targets or prediction targets.

The transmission component 1504 may transmit a measurement and inference report including one or more respective performance metric associated with each measurement target or each prediction target of the first set of one or more measurement targets or prediction targets.

The communication manager 1506 may measure each measurement target of the first set of one or more measurement targets or prediction targets.

The communication manager 1506 may predict each prediction target of the first set of one or more measurement targets or prediction targets.

The transmission component 1504 may transmit, to the serving network node, an indication to add one or more measurement targets or prediction targets to the first set of one or more measurement targets or prediction targets in accordance with determining that at least one performance metric associated with the one or more measurement targets or prediction targets fails to satisfy a performance metric threshold.

The communication manager 1506 may measure each measurement target of the first set of one or more measurement targets or prediction targets.

The communication manager 1506 may predict each prediction target of the first set of one or more measurement targets or prediction targets.

The transmission component 1504 may transmit, to the serving network node, an indication to remove one or more measurement targets or prediction targets from the first set of one or more measurement targets or prediction targets in accordance with determining that at least one performance metric associated with the one or more measurement targets or prediction targets fails to satisfy a performance metric threshold.

The transmission component 1504 may transmit, to the serving network node, a capability information message indicating one or more supported prediction or measurement functionalities, wherein the updated configuration indicates the second set of one or more measurement targets or prediction targets in accordance with the one or more supported prediction or measurement functionalities.

The communication manager 1506 may predict, using a beam prediction model in accordance with receiving the updated configuration, one or more targets of the second set of one or more measurement targets or prediction targets.

The reception component 1502 may receive, from the serving network node, a paging message to pause measurement and inference reporting.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a diagram of an example apparatus 1600 for wireless communication. The apparatus 1600 may be a network node, or a network node may include the apparatus 1600. In some aspects, the apparatus 1600 includes a reception component 1602, a transmission component 1604, or a communication manager 1606, which may be in communication with one another (for example, via one or more buses or one or more other components). In some aspects, the communication manager 1606 is the communication manager 155 described in connection with FIG. 1. As shown, the apparatus 1600 may communicate with another apparatus 1608, such as a UE or a network node (such as a CU, a DU, an RU, or a base station), using the reception component 1602 and the transmission component 1604. The communication manager 1606 may be included in, or implemented via, a processing system (for example, the processing system 145 described in connection with FIG. 1) of the network node.

In some aspects, the apparatus 1600 may be configured to perform one or more operations described herein in connection with FIGS. 7-11. Additionally, or alternatively, the apparatus 1600 may be configured to perform one or more processes described herein, such as process 1300 of FIG. 13, process 1400 of FIG. 14, or a combination thereof. In some aspects, the apparatus 1600 or one or more components shown in FIG. 16 may include one or more components of the network node described in connection with FIG. 1. Additionally, or alternatively, one or more components shown in FIG. 16 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1602 may receive communications, such as reference signals, control information, data communications, or a combination thereof, from the apparatus 1608. The reception component 1602 may provide received communications to one or more other components of the apparatus 1600. In some aspects, the reception component 1602 may perform signal processing on the received communications, and may provide the processed signals to the one or more other components of the apparatus 1600. In some aspects, the reception component 1602 may include one or more components of the network node described above in connection with FIG. 1, such as a radio, one or more RF chains, one or more transceivers, or one or more modems, each of which may in turn be coupled with one or more antennas of the network node. In some aspects, the reception component 1602 or the transmission component 1604 may include or may be included in a network interface. The network interface may be configured to obtain or output signals for the apparatus 1600 via one or more communications links, such as a backhaul link, a midhaul link, or a fronthaul link.

The transmission component 1604 may transmit communications, such as reference signals, control information, data communications, or a combination thereof, to the apparatus 1608. In some aspects, one or more other components of the apparatus 1600 may generate communications and may provide the generated communications to the transmission component 1604 for transmission to the apparatus 1608. In some aspects, the transmission component 1604 may perform signal processing on the generated communications, and may transmit the processed signals to the apparatus 1608. In some aspects, the transmission component 1604 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1604 may be co-located with the reception component 1602.

The communication manager 1606 may support operations of the reception component 1602 or the transmission component 1604. For example, the communication manager 1606 may receive information associated with configuring reception of communications by the reception component 1602 or transmission of communications by the transmission component 1604. Additionally, or alternatively, the communication manager 1606 may generate or provide control information to the reception component 1602 or the transmission component 1604 to control reception or transmission of communications.

The transmission component 1604 may transmit, to a UE, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node. The reception component 1602 may receive, from the UE, a measurement or prediction report including one or more measurements or predictions corresponding to the first set of one or more measurement targets or prediction targets in accordance with the configuration. The transmission component 1604 may transmit, to the UE, a life cycle management message including an updated configuration that indicates a second set of one or more measurement targets or prediction targets associated with communications between the UE and at least one of the serving network node or the neighbor network node.

The reception component 1602 may receive a measurement and inference report including a performance metric associated with each measurement target and each prediction target of the first set of one or more measurement targets or prediction targets.

The reception component 1602 may receive, from the UE, an indication to add one or more measurement targets or prediction targets to the first set of one or more measurement targets or prediction targets in accordance with determining that at least one performance metric associated with the one or more measurement targets or prediction targets fails to satisfy a performance metric threshold.

The reception component 1602 may receive, from the UE, an indication to remove one or more measurement targets or prediction targets from the first set of one or more measurement targets or prediction targets in accordance with determining that at least one performance metric associated with the one or more measurement targets or prediction targets fails to satisfy a performance metric threshold.

The reception component 1602 may receive, from the UE, a capability information message indicating one or more supported prediction or measurement functionalities, wherein the updated configuration indicates the second set of one or more measurement targets or prediction targets in accordance with the one or more supported prediction or measurement functionalities.

The transmission component 1604 may transmit, to the UE, a paging message to pause measurement and inference reporting.

The transmission component 1604 may transmit, to the UE, a request to provide a measurement and inference report for all configured cells and beams.

The communication manager 1606 may communicate, with the neighbor network node, the configuration that indicates the first set of one or more measurement targets or prediction targets.

The communication manager 1606 may monitor one or more performance metrics associated with the first set of one or more measurement targets or prediction targets.

The transmission component 1604 may transmit, to the neighbor network node, an indication of the updated configuration.

The reception component 1602 may receive an acknowledgement message in response to the updated configuration, wherein transmitting the life cycle management message is in accordance with receiving the acknowledgement message.

The communication manager 1606 may forward, to the neighbor network node, the measurement or prediction report including one or more measurements or predictions corresponding to the first set of one or more measurement targets or prediction targets in accordance with the configuration.

The reception component 1602 may receive the updated configuration in response to forwarding the measurement or prediction report, wherein transmitting the updated configuration is in accordance with receiving the updated configuration.

The reception component 1602 or the transmission component 1604 may communicate, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node. The transmission component 1604 may transmit, to the second network node, an updated configuration that indicates a second set of one or more measurement targets or prediction targets associated with communications between the UE and at least one of the first network node or the second network node.

The communication manager 1606 may predict the one or more parameters associated with the UE mobility, wherein the one or more parameters includes at least one of a fixed quantity of highest-ranked cells according to cell quality, a fixed quantity of highest-ranked beams of a serving cell associated with a serving network node, a fixed quantity of highest-ranked beams per configured cell on a frequency of the serving cell, a fixed quantity of highest-ranked beams across a configured cell on the frequency of the serving cell, a fixed quantity of highest-ranked beams per configured cell on one or more frequencies other than the frequency of the serving cell, a fixed quantity of highest-ranked beams across a configured cell on the one or more frequencies other than the frequency of the serving cell, a quality associated with each of the serving cell and one or more neighbor cells, a radio measurement of beams of the serving cell, a radio measurement of beams of one or more neighboring cells on a same frequency, a radio measurement of beams of neighboring cells on frequencies other than serving cell frequency a measurement event associated with at least one of the serving cell or one or more beams associated with the serving cell, a measurement event associated with the serving cell and one or more secondary cells associated with the serving cell, a measurement event associated with at least one of the serving cell of the serving network node, or one or more beams of the serving cell, and at least one of the neighbor cell of a neighbor network node, or one or more beams of the neighbor cell, a radio link failure event at the UE, or a handover failure event at the UE.

The reception component 1602 may receive, from the second network node, an acknowledgement message in response to the updated configuration.

The transmission component 1604 may transmit, to the UE, an indication of the updated configuration in accordance with receiving the acknowledgement message.

The communication manager 1606 may remove or adding one or more measurement targets or prediction targets from the first set of one or more measurement targets or prediction targets to obtain the second set of one or more measurement targets or prediction targets.

The reception component 1602 may receive, from the UE, a measurement or prediction report including one or more measurements or predictions corresponding to the first set of one or more measurement targets or prediction targets in accordance with the configuration.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

The following provides an overview of some Aspects of the present disclosure:

Aspect 1: A method of wireless communication performed by a user equipment (UE), comprising: receiving, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node; transmitting, to the serving network node, a measurement or prediction report including one or more measurements or predictions corresponding to the first set of one or more measurement targets or prediction targets in accordance with the configuration; and receiving, from the serving network node, a life cycle management message including an updated configuration that indicates a second set of one or more measurement targets or prediction targets associated with communications between the UE and at least one of the serving network node or the neighbor network node.

Aspect 2: The method of Aspect 1, further comprising: predicting the one or more parameters associated with the UE mobility, wherein the one or more parameters includes at least one of: a fixed quantity of highest-ranked cells according to cell quality, a fixed quantity of highest-ranked beams of a serving cell associated with the serving network node, a fixed quantity of highest-ranked beams per configured cell on a frequency of the serving cell, a fixed quantity of highest-ranked beams across a configured cell on the frequency of the serving cell, a fixed quantity of highest-ranked beams per configured cell on one or more frequencies other than the frequency of the serving cell, a fixed quantity of highest-ranked beams across a configured cell on the one or more frequencies other than the frequency of the serving cell, a quality associated with each of the serving cell and one or more neighbor cells, a radio measurement of beams of the serving cell, a radio measurement of beams of one or more neighboring cells on a same frequency, a radio measurement of beams of neighboring cells on frequencies other than serving cell frequency a measurement event associated with at least one of the serving cell or one or more beams associated with the serving cell, a measurement event associated with the serving cell and one or more secondary cells associated with the serving cell, a measurement event associated with at least one of the serving cell of the serving network node, or one or more beams of the serving cell, and at least one of the neighbor cell of the neighbor network node, or one or more beams of the neighbor cell, a radio link failure event at the UE, or a handover failure event at the UE.

Aspect 3: The method of any of Aspects 1-2, further comprising: measuring each measurement target of the first set of one or more measurement targets or prediction targets; predicting each prediction target of the first set of one or more measurement targets or prediction targets; and transmitting a measurement and inference report including one or more respective performance metric associated with each measurement target or each prediction target of the first set of one or more measurement targets or prediction targets.

Aspect 4: The method of any of Aspects 1-3, wherein the life cycle management message includes an indication to add one or more measurement targets or prediction targets to the first set of one or more measurement targets or prediction targets.

Aspect 5: The method of any of Aspects 1-4, wherein the life cycle management message includes an indication to remove one or more measurement targets or prediction targets from the first set of one or more measurement targets or prediction targets to obtain the second set of one or more measurement targets or prediction targets.

Aspect 6: The method of any of Aspects 1-5, further comprising: measuring each measurement target of the first set of one or more measurement targets or prediction targets; predicting each prediction target of the first set of one or more measurement targets or prediction targets; and transmitting, to the serving network node, an indication to add one or more measurement targets or prediction targets to the first set of one or more measurement targets or prediction targets in accordance with determining that at least one performance metric associated with the one or more measurement targets or prediction targets fails to satisfy a performance metric threshold.

Aspect 7: The method of Aspect 6, wherein receiving the life cycle management message including the updated configuration is in response to transmitting the indication to add the one or more measurement targets or prediction targets.

Aspect 8: The method of any of Aspects 1-7, further comprising: measuring each measurement target of the first set of one or more measurement targets or prediction targets; predicting each prediction target of the first set of one or more measurement targets or prediction targets; and transmitting, to the serving network node, an indication to remove one or more measurement targets or prediction targets from the first set of one or more measurement targets or prediction targets in accordance with determining that at least one performance metric associated with the one or more measurement targets or prediction targets fails to satisfy a performance metric threshold.

Aspect 9: The method of Aspect 8, wherein receiving the life cycle management message including the updated configuration is in response to transmitting the indication to remove the one or more measurement targets or prediction targets.

Aspect 10: The method of any of Aspects 1-9, further comprising: transmitting, to the serving network node, a capability information message indicating one or more supported prediction or measurement functionalities, wherein the updated configuration indicates the second set of one or more measurement targets or prediction targets in accordance with the one or more supported prediction or measurement functionalities.

Aspect 11: The method of any of Aspects 1-10, further comprising: predicting, using a beam prediction model in accordance with receiving the updated configuration, one or more targets of the second set of one or more measurement targets or prediction targets.

Aspect 12: The method of any of Aspects 1-11, further comprising: receiving, from the serving network node, a paging message to pause measurement and inference reporting.

Aspect 13: The method of any of Aspects 1-12, wherein the second set of one or more measurement targets or prediction targets is a modified set of prediction targets according to previous prediction performance metrics.

Aspect 14: The method of any of Aspects 1-13, wherein the one or more measurement targets or prediction targets include at least one of: one or more frequencies, one or more cells, one or more communication beams of a serving cell associated with the serving network node, one or more communication beams, of a neighboring cell associated with the neighbor network node, having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction.

Aspect 15: A method of wireless communication performed by a serving network node, comprising: transmitting, to a user equipment (UE), a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node; receiving, from the UE, a measurement or prediction report including one or more measurements or predictions corresponding to the first set of one or more measurement targets or prediction targets in accordance with the configuration; and transmitting, to the UE, a life cycle management message including an updated configuration that indicates a second set of one or more measurement targets or prediction targets associated with communications between the UE and at least one of the serving network node or the neighbor network node.

Aspect 16: The method of Aspect 15, further comprising: receiving a measurement and inference report including a performance metric associated with each measurement target and each prediction target of the first set of one or more measurement targets or prediction targets.

Aspect 17: The method of any of Aspects 15-16, wherein the life cycle management message includes an indication to add one or more measurement targets or prediction targets to the first set of one or more measurement targets or prediction targets.

Aspect 18: The method of any of Aspects 15-17, wherein the life cycle management message includes an indication to remove one or more measurement targets or prediction targets from the first set of one or more measurement targets or prediction targets to obtain the second set of one or more measurement targets or prediction targets.

Aspect 19: The method of any of Aspects 15-18, further comprising: receiving, from the UE, an indication to add one or more measurement targets or prediction targets to the first set of one or more measurement targets or prediction targets in accordance with determining that at least one performance metric associated with the one or more measurement targets or prediction targets fails to satisfy a performance metric threshold.

Aspect 20: The method of Aspect 19, wherein transmitting the life cycle management message including the updated configuration is in response to transmitting the indication to add the one or more measurement targets or prediction targets.

Aspect 21: The method of any of Aspects 15-20, further comprising: receiving, from the UE, an indication to remove one or more measurement targets or prediction targets from the first set of one or more measurement targets or prediction targets in accordance with determining that at least one performance metric associated with the one or more measurement targets or prediction targets fails to satisfy a performance metric threshold.

Aspect 22: The method of Aspect 21, wherein transmitting the life cycle management message including the updated configuration is in response to transmitting the indication to remove the one or more measurement targets or prediction targets.

Aspect 23: The method of any of Aspects 15-22, further comprising: receiving, from the UE, a capability information message indicating one or more supported prediction or measurement functionalities, wherein the updated configuration indicates the second set of one or more measurement targets or prediction targets in accordance with the one or more supported prediction or measurement functionalities.

Aspect 24: The method of any of Aspects 15-23, further comprising: transmitting, to the UE, a paging message to pause measurement and inference reporting.

Aspect 25: The method of any of Aspects 15-24, wherein the second set of one or more measurement targets or prediction targets is a modified set of prediction targets according to one or more past prediction performance metrics.

Aspect 26: The method of any of Aspects 15-25, wherein the updated configuration indicates that the UE is to perform beam inference reporting for a subset of all predicted beams.

Aspect 27: The method of any of Aspects 15-26, wherein the updated configuration indicates one or more inter-frequency prediction targets.

Aspect 28: The method of any of Aspects 15-27, further comprising: transmitting, to the UE, a request to provide a measurement and inference report for all configured cells and beams.

Aspect 29: The method of any of Aspects 15-28, wherein the one or more measurement targets or prediction targets include at least one of: one or more frequencies, one or more cells, one or more communication beams of a serving cell associated with the serving network node, one or more communication beams, of a neighboring cell associated with the neighbor network node, having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction.

Aspect 30: The method of any of Aspects 15-29, further comprising: communicating, with the neighbor network node, the configuration that indicates the first set of one or more measurement targets or prediction targets.

Aspect 31: The method of any of Aspects 15-30, further comprising: monitoring one or more performance metrics associated with the first set of one or more measurement targets or prediction targets.

Aspect 32: The method of any of Aspects 15-31, further comprising: transmitting, to the neighbor network node, an indication of the updated configuration; and receiving an acknowledgement message in response to the updated configuration, wherein transmitting the life cycle management message is in accordance with receiving the acknowledgement message.

Aspect 33: The method of Aspect 32, wherein the acknowledgement message includes an indication to add or remove one or more measurement targets or prediction targets from the updated configuration.

Aspect 34: The method of any of Aspects 15-33, further comprising: forwarding, to the neighbor network node, the measurement or prediction report including one or more measurements or predictions corresponding to the first set of one or more measurement targets or prediction targets in accordance with the configuration; and receiving the updated configuration in response to forwarding the measurement or prediction report, wherein transmitting the updated configuration is in accordance with receiving the updated configuration.

Aspect 35: A method of wireless communication performed by a first network node, comprising: communicating, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node; and transmitting, to the second network node, an updated configuration that indicates a second set of one or more measurement targets or prediction targets associated with communications between the UE and at least one of the first network node or the second network node.

Aspect 36: The method of Aspect 35, further comprising: predicting the one or more parameters associated with the UE mobility, wherein the one or more parameters includes at least one of: a fixed quantity of highest-ranked cells according to cell quality, a fixed quantity of highest-ranked beams of a serving cell associated with a serving network node, a fixed quantity of highest-ranked beams per configured cell on a frequency of the serving cell, a fixed quantity of highest-ranked beams across a configured cell on the frequency of the serving cell, a fixed quantity of highest-ranked beams per configured cell on one or more frequencies other than the frequency of the serving cell, a fixed quantity of highest-ranked beams across a configured cell on the one or more frequencies other than the frequency of the serving cell, a quality associated with each of the serving cell and one or more neighbor cells, a radio measurement of beams of the serving cell, a radio measurement of beams of one or more neighboring cells on a same frequency, a radio measurement of beams of neighboring cells on frequencies other than serving cell frequency a measurement event associated with at least one of the serving cell or one or more beams associated with the serving cell, a measurement event associated with the serving cell and one or more secondary cells associated with the serving cell, a measurement event associated with at least one of the serving cell of the serving network node, or one or more beams of the serving cell, and at least one of the neighbor cell of a neighbor network node, or one or more beams of the neighbor cell, a radio link failure event at the UE, or a handover failure event at the UE.

Aspect 37: The method of any of Aspects 35-36, further comprising: receiving, from the second network node, an acknowledgement message in response to the updated configuration; and transmitting, to the UE, an indication of the updated configuration in accordance with receiving the acknowledgement message.

Aspect 38: The method of Aspect 37, wherein the acknowledgement message includes an indication to add or remove one or more measurement targets or prediction targets from the updated configuration.

Aspect 39: The method of any of Aspects 35-38, wherein the configuration includes a request for the second network node to provide performance metrics associated with the first set of one or more measurement targets or prediction targets.

Aspect 40: The method of any of Aspects 35-39, wherein the first network node is a serving network node, and the second network node is a neighbor network node.

Aspect 41: The method of any of Aspects 35-40, wherein the first network node is a neighbor network node, and the second network node is a serving network node.

Aspect 42: The method of any of Aspects 35-41, further comprising: removing or adding, by the first network node, one or more measurement targets or prediction targets from the first set of one or more measurement targets or prediction targets to obtain the second set of one or more measurement targets or prediction targets.

Aspect 43: The method of any of Aspects 35-42, further comprising: receiving, from a UE, a measurement or prediction report including one or more measurements or predictions corresponding to the first set of one or more measurement targets or prediction targets in accordance with the configuration.

Aspect 44: The method of any of Aspects 35-43, wherein the one or more measurement targets or prediction targets include at least one of: one or more frequencies, one or more cells, one or more communication beams of a serving cell associated with a serving network node, one or more communication beams, of a neighboring cell associated with a neighbor network node, having a same communication frequency as communication beams associated with the serving cell, one or more beams across two or more neighboring cells having a same communication frequency as communication beams associated with the serving cell, one or more beams of the neighboring cell having a different frequency than communication beams associated with the serving cell, one or more beams across two or more neighboring cells having a different communication frequency than communication beams associated with the serving cell, or one or more events for event prediction.

Aspect 45: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-44.

Aspect 46: An apparatus for wireless communication at a device, the apparatus comprising one or more memories and one or more processors coupled to the one or more memories, the one or more processors configured to cause the device to perform the method of one or more of Aspects 1-44.

Aspect 47: An apparatus for wireless communication, the apparatus comprising at least one means for performing the method of one or more of Aspects 1-44.

Aspect 48: A non-transitory computer-readable medium storing code for wireless communication, the code comprising instructions executable by one or more processors to perform the method of one or more of Aspects 1-44.

Aspect 49: A non-transitory computer-readable medium storing a set of instructions for wireless communication, the set of instructions comprising one or more instructions that, when executed by one or more processors of a device, cause the device to perform the method of one or more of Aspects 1-44.

Aspect 50: A device for wireless communication, the device comprising a processing system that includes one or more processors and one or more memories coupled with the one or more processors, the processing system configured to cause the device to perform the method of one or more of Aspects 1-44.

Aspect 51: An apparatus for wireless communication at a device, the apparatus comprising one or more memories and one or more processors coupled to the one or more memories, the one or more processors individually or collectively configured to cause the device to perform the method of one or more of Aspects 1-44.

Aspect 52: A device comprising a processing system that includes one or more processors and one or more code-storing memories coupled with the one or more processors, the processing system configured to cause the device to perform the method of one or more of Aspects 1-44.

Aspect 53: A device comprising a processing system that includes processor circuitry and code-storing memory circuitry, the processing system configured to cause the device to perform the method of one or more of Aspects 1-44.

Further disclosure is included in the appendix. The appendix is provided as an example only and is to be considered part of the specification. A definition, illustration, or other description in the appendix does not supersede or override similar information included in the detailed description or figures. Furthermore, a definition, illustration, or other description in the detailed description or figures does not supersede or override similar information included in the appendix. Furthermore, the appendix is not intended to limit the disclosure of possible aspects.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, when used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
receive, from a serving network node, a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node;
transmit, to the serving network node, a measurement or prediction report including one or more measurements or predictions corresponding to the first set of one or more measurement targets or prediction targets in accordance with the configuration; and
receive, from the serving network node, a life cycle management message including an updated configuration that indicates a second set of one or more measurement targets or prediction targets associated with communications between the UE and at least one of the serving network node or the neighbor network node.

2. The UE of claim 1, wherein the processing system is configured to cause the UE to:
predict the one or more parameters associated with the UE mobility, wherein the one or more parameters includes at least one of:
a fixed quantity of highest-ranked cells according to cell quality,
a fixed quantity of highest-ranked beams of a serving cell associated with the serving network node,
a fixed quantity of highest-ranked beams per configured cell on a frequency of the serving cell,
a fixed quantity of highest-ranked beams across a configured cell on the frequency of the serving cell,
a fixed quantity of highest-ranked beams per configured cell on one or more frequencies other than the frequency of the serving cell,
a fixed quantity of highest-ranked beams across a configured cell on the one or more frequencies other than the frequency of the serving cell,
a quality associated with each of the serving cell and one or more neighbor cells,
a radio measurement of beams of the serving cell,
a radio measurement of beams of one or more neighboring cells on a same frequency,
a radio measurement of beams of neighboring cells on frequencies other than serving cell frequency
a measurement event associated with at least one of the serving cell or one or more beams associated with the serving cell,
a measurement event associated with the serving cell and one or more secondary cells associated with the serving cell,
a measurement event associated with at least one of the serving cell of the serving network node, or one or more beams of the serving cell, and at least one of the neighbor cell of the neighbor network node, or one or more beams of the neighbor cell,
a radio link failure event at the UE, or
a handover failure event at the UE.

3. The UE of claim 1, wherein the processing system is configured to cause the UE to:
measure each measurement target of the first set of one or more measurement targets or prediction targets;
predict each prediction target of the first set of one or more measurement targets or prediction targets; and
transmit a measurement and inference report including one or more respective performance metrics associated with each measurement target or each prediction target of the first set of one or more measurement targets or prediction targets.

4. The UE of claim 1, wherein the processing system is configured to cause the UE to:
measure each measurement target of the first set of one or more measurement targets or prediction targets;
predict each prediction target of the first set of one or more measurement targets or prediction targets; and
transmit, to the serving network node, an indication to add one or more measurement targets or prediction targets to the first set of one or more measurement targets or prediction targets in accordance with determining that at least one performance metric associated with the one or more measurement targets or prediction targets fails to satisfy a performance metric threshold, wherein receiving the updated configuration is in response to transmitting the indication.

5. The UE of claim 1, wherein the processing system is configured to cause the UE to:
measure each measurement target of the first set of one or more measurement targets or prediction targets;
predict each prediction target of the first set of one or more measurement targets or prediction targets; and
transmit, to the serving network node, an indication to remove one or more measurement targets or prediction targets from the first set of one or more measurement targets or prediction targets in accordance with determining that at least one performance metric associated with the one or more measurement targets or prediction targets fails to satisfy a performance metric threshold, wherein receiving the updated configuration is in response to transmitting the indication.

6. The UE of claim 1, wherein the processing system is configured to cause the UE to:
transmit, to the serving network node, a capability information message indicating one or more supported prediction or measurement functionalities, wherein the updated configuration indicates the second set of one or more measurement targets or prediction targets in accordance with the one or more supported prediction or measurement functionalities.

7. The UE of claim 1, wherein the processing system is configured to cause the UE to:
predict, using a beam prediction model in accordance with receiving the updated configuration, one or more targets of the second set of one or more measurement targets or prediction targets.

8. The UE of claim 1, wherein the processing system is configured to cause the UE to:
receive, from the serving network node, a paging message to pause measurement and inference reporting.

9. A serving network node, comprising:
a processing system that includes one or more processors and one or more code-storing memories coupled with the one or more processors, the processing system configured to cause the serving network node to:
transmit, to a user equipment (UE), a configuration for predicting one or more parameters associated with UE mobility, wherein the configuration indicates a first set of one or more measurement targets or prediction targets including at least one measurement or prediction target associated with communications between the UE and at least one of the serving network node or a neighbor network node;
receive, from the UE, a measurement or prediction report including one or more measurements or predictions corresponding to the first set of one or more measurement targets or prediction targets in accordance with the configuration; and
transmit, to the UE, a life cycle management message including an updated configuration that indicates a second set of one or more measurement targets or prediction targets associated with communications between the UE and at least one of the serving network node or the neighbor network node.

10. The serving network node of claim 9, wherein the processing system is configured to cause the serving network node to:
receive a measurement and inference report including a performance metric associated with each measurement target and each prediction target of the first set of one or more measurement targets or prediction targets.

11. The serving network node of claim 9, wherein the processing system is configured to cause the serving network node to:
communicate, with the neighbor network node, the configuration that indicates the first set of one or more measurement targets or prediction targets.

12. The serving network node of claim 9, wherein the processing system is configured to cause the serving network node to:
monitor one or more performance metrics associated with the first set of one or more measurement targets or prediction targets.

13. The serving network node of claim 9, wherein the processing system is configured to cause the serving network node to:
transmit, to the neighbor network node, an indication of the updated configuration; and
receive an acknowledgement message in response to the updated configuration, wherein transmitting the life cycle management message is in accordance with receiving the acknowledgement message.

14. The serving network node of claim 13, wherein the acknowledgement message includes an indication to add or remove one or more measurement targets or prediction targets from the updated configuration.

15. The serving network node of claim 9, wherein the processing system is configured to cause the serving network node to:
forward, to the neighbor network node, the measurement or prediction report including one or more measurements or predictions corresponding to the first set of one or more measurement targets or prediction targets in accordance with the configuration; and
receive the updated configuration in response to forwarding the measurement or prediction report, wherein transmitting the updated configuration is in accordance with receiving the updated configuration.

16. A first network node, comprising:
a processing system that includes one or more processors and one or more code-storing memories coupled with the one or more processors, the processing system configured to cause the first network node to:
communicate, with a second network node, a configuration for predicting one or more parameters associated with UE mobility, wherein the configuration indicates a first set of one or more measurement targets or prediction targets including at least one measurement or prediction target associated with communications between a UE and at least one of the first network node or the second network node; and
transmit, to the second network node, an updated configuration that indicates a second set of one or more measurement targets or prediction targets associated with communications between the UE and at least one of the first network node or the second network node.

17. The first network node of claim 16, wherein the processing system is configured to cause the first network node to:
predict the one or more parameters associated with the UE mobility, wherein the one or more parameters includes at least one of:
a fixed quantity of highest-ranked cells according to cell quality,
a fixed quantity of highest-ranked beams of a serving cell associated with a serving network node,
a fixed quantity of highest-ranked beams per configured cell on a frequency of the serving cell,
a fixed quantity of highest-ranked beams across a configured cell on the frequency of the serving cell,
a fixed quantity of highest-ranked beams per configured cell on one or more frequencies other than the frequency of the serving cell,
a fixed quantity of highest-ranked beams across a configured cell on the one or more frequencies other than the frequency of the serving cell,
a quality associated with each of the serving cell and one or more neighbor cells,
a radio measurement of beams of the serving cell,
a radio measurement of beams of one or more neighboring cells on a same frequency,
a radio measurement of beams of neighboring cells on frequencies other than serving cell frequency
a measurement event associated with at least one of the serving cell or one or more beams associated with the serving cell,
a measurement event associated with the serving cell and one or more secondary cells associated with the serving cell,
a measurement event associated with at least one of the serving cell of the serving network node, or one or more beams of the serving cell, and at least one of the neighbor cell of a neighbor network node, or one or more beams of the neighbor cell,
a radio link failure event at the UE, or
a handover failure event at the UE.

18. The first network node of claim 16, wherein the processing system is configured to cause the first network node to:
receive, from the second network node, an acknowledgement message in response to the updated configuration; and
transmit, to the UE, an indication of the updated configuration in accordance with receiving the acknowledgement message.

19. The first network node of claim 16, wherein the processing system is configured to cause the first network node to:
remove or add one or more measurement targets or prediction targets from the first set of one or more measurement targets or prediction targets to obtain the second set of one or more measurement targets or prediction targets.

20. The first network node of claim 16, wherein the processing system is configured to cause the first network node to:
receive, from a UE, a measurement or prediction report including one or more measurements or predictions corresponding to the first set of one or more measurement targets or prediction targets in accordance with the configuration.
